(19) United States
(12) Patent Application Publication
(10) Pub. No.: US 2024/0323182 A1
(43) Pub. Date: Sep. 26, 2024

(54) CONTACTLESS CARD BASED AUTHENTICATION OF SOCIAL MEDIA POST

(71) Applicant: Capital One Services, LLC, McLean, VA (US)

(72) Inventors: Bob Uni KOSHY, Henrico, VA (US); Thomas POOLE, Chantilly, VA (US); Michael MOSSOBA, Great Falls, VA (US)

(73) Assignee: Capital One Services, LLC, McLean, VA (US)

(21) Appl. No.: 18/614,242

(22) Filed: Mar. 22, 2024

Related U.S. Application Data
(60) Provisional application No. 63/454,151, filed on Mar. 23, 2023.

(51) Int. Cl. H04L 9/40; G06K 19/07

(52) U.S. Cl. CPC H04L 63/0853; G06K 19/0723; H04L 63/0435

(57) ABSTRACT

The disclosed systems and techniques discussed herein include one or more servers receiving a request to authenticate a publisher's identity for publishing a post. A server receives encrypted data from a computing device, generated by a contactless card, and transmitted through the computing device. The server decrypts the encrypted data using a key associated with the contactless card. Based on the decryption, the server authenticates the identity of the publisher. If the authentication is successful, the server sends an indication of the publisher's authenticity, which enables the display of a status symbol on the post as an indicator that the publisher's identity is verified.

### CROSS-REFERENCE TO RELATED APPLICATIONS

This application claims the benefit of priority to U.S. Provisional Application Ser. No. 63/454,151, filed Mar. 23, 2023, the entirety of which is incorporated herein by reference.

### BACKGROUND

In some instances, computer systems require a user to be authenticated to provide the user access to the computer system's functionalities. Examples of such user authentication scenarios include accessing an email system, a banking system, a social media network, and several other such computer systems. In several scenarios, it is further required to indicate to other users of the system that a function of the system has been accessed and/or executed by a verified user. Such indication may be required to establish trust of the other users in the results of the access/execution, and, thus, the other users' trust in the overall system.

In the past, contactless cards have been utilized to access a door, provide payment, perform transactions, etc. Typically, contactless cards include contact-based functionality (stripe or EMV contact pad) and contactless-based technology such as radio-frequency identification (RFID) technology that may be embedded into the physical cards, such as credit cards, debit cards, identification cards, and other smart cards. The contactless technology allows users to perform various functions by bringing a card within a specific distance of (or tapping on) specific areas of devices, such as point-of-sale terminals, mobile phones, doors, and other computing devices.

### SUMMARY

The present disclosure relates to systems and methods for verifying the identity of a publisher in order to enable the secure publishing of a post. The method involves several steps that take place within a system. Initially, the system receives a request to authenticate the identity of a publisher who intends to publish a post. This request serves to ensure that the publisher's identity can be verified before allowing them to publish content. The authentication process is crucial for maintaining a trustworthy platform. Next, the system receives encrypted data from the contactless card via a computing device. This encrypted data is generated by a contactless card, which securely stores information related to the publisher's identity. In some instances, the computing device acts as an intermediary, facilitating the communication between the contactless card and the system. Upon receiving the encrypted data, the system proceeds to decrypt it. To decrypt the data, the system employs a key scheme that is associated with the contactless card. By utilizing the correct key(s), the system can effectively reverse the encryption process and obtain data. Once the data is decrypted, the system performs an authentication check based on the decrypted information. This authentication check is conducted to ensure that the publisher's identity is valid and authorized. By validating the identity, the system can ensure that only trustworthy publishers have access to the platform. In the event that the authentication process is successful, indicating that the publisher's identity has been authenticated, the system sends an indication to enable the display of a status symbol on the post. This status symbol provides a visual representation to other users, indicating that the publisher's identity is verified and authentic.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1A illustrates an aspect of the subject matter in accordance with one embodiment.

FIG. 1B illustrates an aspect of the subject matter in accordance with one embodiment.

FIG. 2 illustrates an aspect of the subject matter in accordance with one embodiment.

FIG. 3 illustrates an aspect of the subject matter in accordance with one embodiment.

FIG. 4 illustrates a routine 400 in accordance with one embodiment.

FIG. 5 illustrates a routine 500 in accordance with one embodiment.

FIG. 6A illustrates a contactless card in accordance with one embodiment.

FIG. 6B illustrates a contactless card 104 in accordance with one embodiment.

FIG. 7 illustrates a sequence flow 700 in accordance with one embodiment.

FIG. 8 illustrates a data structure 800 in accordance with one embodiment.

FIG. 9 is a diagram of a key system according to an example embodiment.

FIG. 10 is a flowchart of a method of generating a cryptogram according to an example embodiment.

FIG. 11 illustrates an aspect of the subject matter in accordance with one embodiment.

FIG. 12 illustrates an aspect of the subject matter in accordance with one embodiment.

FIG. 13 illustrates an example of a system 1300 configured to operate in accordance with embodiments discussed herein.

FIG. 14 illustrates an example flow 1400 to perform card key derivation in accordance with embodiments.

FIG. 15 illustrates an aspect of the subject matter in accordance with one embodiment.

FIG. 16 illustrates an aspect of the subject matter in accordance with one embodiment.

FIG. 17 illustrates an aspect of the subject matter in accordance with one embodiment.

FIG. 18 illustrates an aspect of the subject matter in accordance with one embodiment.

FIG. 19 illustrates an aspect of the subject matter in accordance with one embodiment.

FIG. 20 illustrates a routine 2000 in accordance with one embodiment.

FIG. 21 illustrates an aspect of the subject matter in accordance with one embodiment.

FIG. 22 illustrates an aspect of the subject matter in accordance with one embodiment.

FIG. 23 illustrates a computer architecture 2300 in accordance with one embodiment.

### DETAILED DESCRIPTION

Embodiments disclosed herein provide techniques for secure verification of a user's identity using a contactless card when the user is requesting to access an account on a social media system, when the user requests to publish a social media post (“post”), or performing other tasks. Further, embodiments described herein provide other users of the system an indication that the post has been published by an authorized user of the account that published the post by providing a notification via a user-interface of the electronic account. Particularly, in the case where the social media account provides the user a public profile to disseminate information, opinions, etc., verifying the user's identity is an important technical challenge to be solved. Accordingly, embodiments described herein address an internet-centric challenge where, particularly in the case of accounts used to disseminate information, opinion, media, etc., the disseminating user's identity is to be verified, and a notification is to be provided to assure other users (i.e., viewers, either from the public or a private group) that the account's owner's identity and/or an authorized user (agent of the account owner) publishing the post has been verified. The internet-centric challenge is critical because of the presence of fraudulent entities, such as bots, trolls, fake accounts, etc. While user-account providers, such as social media platforms, are working to combat such “fakes” or fraudulent users through algorithm changes and bots of their own, eradicating the fakes poses a significant challenge. There have been several incidents where such fakes have caused disruptions, such as when a delivery guy impersonated the then United States' President's family members to spread conspiracy theories, news outlet impersonators spreading misleading information about the 2020 U.S. elections, etc.

It is especially important for social media influencers, thought leaders, and small businesses to be verified and indicate that they are verified so that fake accounts cannot impersonate them. Having a verified user profile makes it difficult for scammers and fakes to use the verified user's name/identity to spread misinformation, hold fake events to steal the verified user's followers' information, and perform other such disruptive actions, that eventually leads to mistrust of the user as well as of the user-account provider.

Embodiments described herein address this internet-centric challenge by using a computing device, such as a contactless card, to verify identity of the user by generating a data or a token indicative of the user's identity. The data or token can be communicated in a wired, or wireless manner (e.g., using a near field communications interface, internet of things, etc.) to a second computing device that is being used to access the user-account, e.g., through a verification process discussed herein. For example, the device receiving the data or token from the contactless card may perform an authentication operation. In some instances, the data or token may be sent to a third-party authentication server configured to authenticate the data or token. In implementation, verification utilizing data or a token from the card provides additional security over previous solutions because the identify of the user is highly authenticated during an initiation stage of the contactless card, and the ongoing authentication operations are performed by a third-party, distinct from a social media platform, for example.

For example, consider a scenario where a user wants to publish a post via his/her social media account, such as FACEBOOK®, TWITTER®, THREADS®, LINKEDIN®, etc. The user sends a request to publish the post via the user-account from a computing device, such as a mobile phone, a tablet computer, a laptop computer, a desktop computer, or any other computing device. The social media platform and other users of the platform desire to ensure that the user is who he/she claims to be or at least that the post is published by an authorized user of the user-account. In some embodiments, the social media platform may determine if verification of the user is required based on the content of the post. If the identity verification is deemed necessary based on the sensitivity of the post, the computing device instructs the user to provide another device, such as the contactless card, to verify the user's identity. The computing device communicates with the contactless card to exchange data to authenticate the user. The data may be a token or unique identifier to identify the user associated with the contactless card. In some instances, the contactless card sends the data or token in a cryptogram in accordance with a wireless standard, such as Europay, Mastercard, Visa (EMV) over Near-Field Communication (NFC)The computing device receives the cryptogram via wireless communications with the contactless card and sends the cryptogram to a server for verification/authentication of the user. If the server verifies the cryptogram including the data or token, the server may indicate that the authentication was successful. The post is published via the social media account only if the authentication was successful, indicating the user's identity is verified. In some examples, the social media platform facilitates displaying an authentication indicator, status symbol or badge on the post indicating that the identity of the user publishing the post has been verified. In the case where the server fails to verify/authenticate the user, the post may not be published in some embodiments. Alternatively, the post is published absent of the status symbol or badge. Accordingly, in absence of the status symbol, viewers of the post are not guaranteed that the identity of the user publishing the post has been verified. Accordingly, presence/absence of the status symbol puts the viewers on notice whether the user's identity for a particular post has or has not been verified. In some embodiments, in addition to the status symbol, the post may facilitate providing additional meta-information, such as the posting user's geographic location, timing, status (primary user, agent, etc.), etc.

The status symbol can be a text, an image, an icon, a user-interface element, or any other mark that indicates to a viewer that the posting user's identity has been verified. In some embodiments, the status symbol, or a selection of the status symbol, is stored on the contactless card and transmitted to the server for displaying the status symbol upon successful authentication of the user's identity. Alternatively, or in addition, the status symbol and/or its selection is used as a parameter when generating the cryptogram.

Viewers are more likely to trust the information on the verified post as coming from a verified source (the user) as compared to an unverified post. In this manner, embodiments described herein address the technical internet-centric challenge of verifying identity of a user posting on a social media platform. The social media platform may be public or private, such as within a workplace. The social media platform may further include an email server, a messaging service, a blogging service, a video-logging service, a podcasting service, an online publication service, a micro-blogging service, or any other type of web-based service. The challenge described herein is accentuated in cases where viewers/other users trust information provided via a post on the social media network based on the identity of the source of the information (user/owner of the user account) being verified. Embodiments described herein address the challenge by verifying the identity in a secure multi-factored manner and indicating to the other users/viewers that such a verification/authentication has been performed. Further, embodiments described herein determine if such verification/authentication is required based on the sensitivity of the post.

With general reference to notations and nomenclature used herein, the detailed descriptions herein may be presented in terms of program procedures executed on a computer or network of computers. These procedural descriptions and representations are used by those skilled in the art to effectively convey the substance of their work to others skilled in the art.

A procedure is here, and generally, conceived to be a self-consistent sequence of operations leading to a desired result. These operations are those requiring physical manipulations of physical quantities. Usually, though not necessarily, these quantities take the form of electrical, magnetic or optical signals capable of being stored, transferred, combined, compared, and otherwise manipulated. It proves convenient at times, principally for reasons of common usage, to refer to these signals as bits, values, elements, symbols, characters, terms, numbers, or the like. It should be noted, however, that all of these and similar terms are to be associated with the appropriate physical quantities and are merely convenient labels applied to those quantities.

Further, the manipulations performed are often referred to in terms, such as adding or comparing, which are commonly associated with mental operations performed by a human operator. No such capability of a human operator is necessary, or desirable in most cases, in any of the operations described herein, which form part of one or more embodiments. Rather, the operations are machine operations. Useful machines for performing operations of various embodiments include digital computers or similar devices.

Some embodiments may be described using the expression “coupled” and “connected” along with their derivatives. These terms are not necessarily intended as synonyms for each other. For example, some embodiments may be described using the terms “connected” and/or “coupled” to indicate that two or more elements are in direct physical or electrical contact. The term “coupled,” however, may also mean that two or more elements are not in direct contact with each other, but yet still cooperate or interact with each other.

Various embodiments also relate to apparatus or systems for performing these operations. This apparatus may be specially constructed for the required purpose or it may include a computer as selectively activated or reconfigured by a computer program stored in the computer. The procedures presented herein are not inherently related to a particular computer or other apparatus. Various machines may be used with programs written in accordance with the teachings herein, or it may prove convenient to construct more specialized apparatus to perform the required method steps. The required structure for various machines will appear from the description given.

Reference is now made to the drawings, wherein like reference numerals are used to refer to like elements throughout. In the following description, for purposes of explanation, numerous specific details are set forth in order to provide a thorough understanding thereof. However, the novel embodiments can be practiced without these specific details. In other instances, structures and devices are shown in block diagram form in order to facilitate a description thereof. The intention is to cover all modifications, equivalents, and alternatives consistent with the claimed subject matter.

In the Figures and the accompanying description, the designations “a” and “b” and “c” (and similar designators) are intended to be variables representing any positive integer. Thus, for example, if an implementation sets a value for a=5, then a complete set of components 123 illustrated as components 123-1 through 123-a (or 123a) may include components 123-1, 123-2, 123-3, 123-4, and 123-5. The embodiments are not limited in this context.

Operations for the disclosed embodiments may be further described with reference to the following figures. Some of the figures may include a logic flow. Although such figures presented herein may include a particular logic flow, it can be appreciated that the logic flow merely provides an example of how the general functionality as described herein can be implemented. Further, a given logic flow does not necessarily have to be executed in the order presented unless otherwise indicated. Moreover, not all acts illustrated in a logic flow may be required in some embodiments. In addition, the given logic flow may be implemented by a hardware element, a software element executed by a processor, or any combination thereof. The embodiments are not limited in this context.

In some instances, contactless card functions discussed herein may be utilized in a multi-issuer computing environment. These functions may include tap-to functions where a user may tap their contactless card on a device, such as a mobile device, to perform a function. For example, a user may utilize their contactless card to verify their identity, perform a payment, launch applications, log into applications, autofill a form or field, navigate to a specified web location or app on a device, unlock a door, initiate a contactless card, verify themselves, and so forth.

The systems discussed herein enable card issuers or payment providers, such as banks, to issue contactless cards with these tap-to functions to customers while maintaining high-level security in a distributed computing environment. The systems discussed differ from previous solutions because they provide a single platform for multiple issuers to provide the tap-to functionality. Traditionally, each issuer must set up and maintain its own systems to provide contactless card features. This includes maintaining their own hardware, software, databases, security protocols, and so forth, which can become extremely costly for the issuer to maintain.

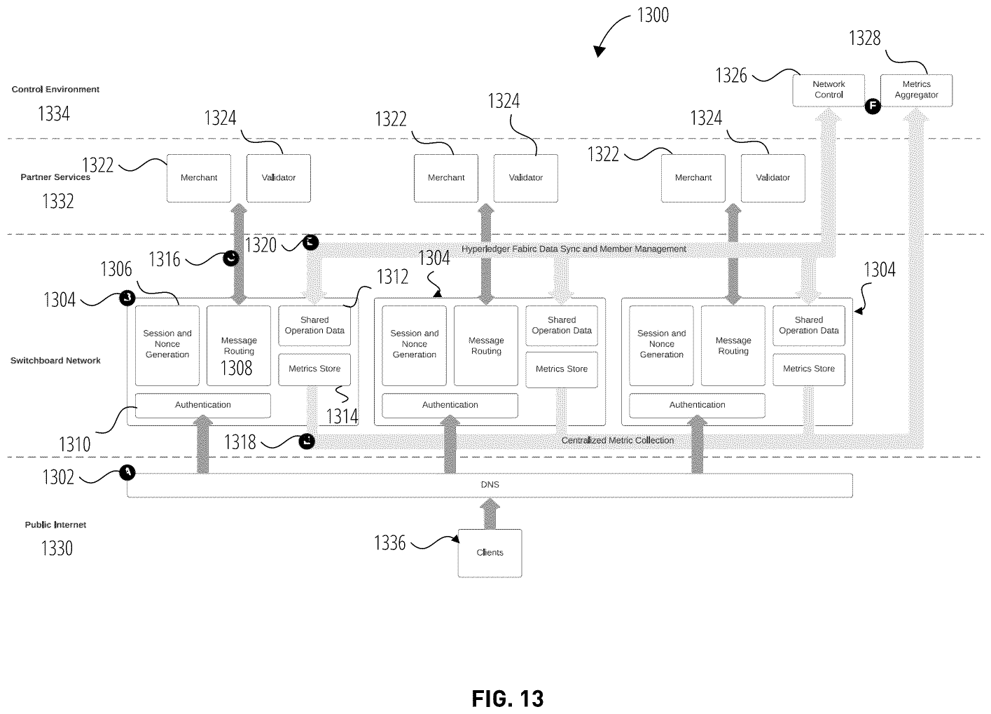

The embodiments discussed herein includes a switchboard routing system that enables issuers to offload much of the processing, storage, and security functionality to a neutral or central system. As will be discussed in more detail in FIG. 13 through FIG. 21, the central system is configured to provide contactless card features for multiple issuers while maintaining a high level of security and data integrity. Each issuer's functionality and data may be separately managed and secured such that another issuer cannot access another issuer's data or functions. These features may be provided by the switchboard system that is configured to process and perform each contactless card function in a secure manner. Additional benefits for issuers may include providing a highly secure authentication option for mobile web, which typically lack the robust authentication options available in a native application.

Further, embodiments discussed herein support tap-to mobile web experiences on both major mobile platforms (iOS®, Android®) by leveraging App Clips® and Javascript® SDK with WebNFC®. For IOS®, embodiments include providing a tap-to software development kit, including functions and services to perform the operations discussed herein on the iOS® platform. The SDK may be installed into the host application, e.g., a native app or web browser app, and includes App Clip® support. The SDK provides functional support for near-field communication between the mobile device and contactless card, installing a native app via App Clips®, and functionality to obscure data and/or portions of a display. In one example, the SDK may be configured to download and install the app from an app store, such as Apples® App Store.

In the Android® operating system environment, embodiments include utilizing a JavaScript SDK. The JavaScript SDK may be installed into a website, e.g., via website source code. The JavaScript SDK also includes functions to support NFC communications between the mobile device contactless card via WebNFC®. The JavaScript SDK may also include functions to provide customizable user interface (UI) capabilities and obfuscation. In embodiments, the JavaScript SDK supports websites utilizing Hypertext Transfer Protocol Secure (HTTPS) and supports the React® library. Embodiments are not limited in this manner and UIs libraries may be supported.

With general reference to notations and nomenclature used herein, one or more portions of the detailed description which follows may be presented in terms of program procedures executed on a computer or network of computers. These procedural descriptions and representations are used by those skilled in the art to most effectively convey the substances of their work to others skilled in the art. A procedure is here, and generally, conceived to be a self-consistent sequence of operations leading to a desired result. These operations are those requiring physical manipulations of physical quantities. Usually, though not necessarily, these quantities take the form of electrical, magnetic, or optical signals capable of being stored, transferred, combined, compared, and otherwise manipulated. It proves convenient at times, principally for reasons of common usage, to refer to these signals as bits, values, elements, symbols, characters, terms, numbers, or the like. It should be noted, however, that all of these and similar terms are to be associated with the appropriate physical quantities and are merely convenient labels applied to those quantities.

Further, these manipulations are often referred to in terms, such as adding or comparing, which are commonly associated with mental operations performed by a human operator. However, no such capability of a human operator is necessary, or desirable in most cases, in any of the operations described herein that form part of one or more embodiments. Rather, these operations are machine operations. Useful machines for performing operations of various embodiments include digital computers as selectively activated or configured by a computer program stored within that is written in accordance with the teachings herein, and/or include apparatus specially constructed for the required purpose or a digital computer. Various embodiments also relate to apparatus or systems for performing these operations. These apparatuses may be specially constructed for the required purpose. The required structure for a variety of these machines will be apparent from the description given.

Reference is now made to the drawings, wherein like reference numerals are used to refer to like elements throughout. In the following description, for the purpose of explanation, numerous specific details are set forth in order to provide a thorough understanding thereof. It may be evident, however, that the novel embodiments can be practiced without these specific details. In other instances, well-known structures and devices are shown in block diagram form in order to facilitate a description thereof. The intention is to cover all modification, equivalents, and alternatives within the scope of the claims.

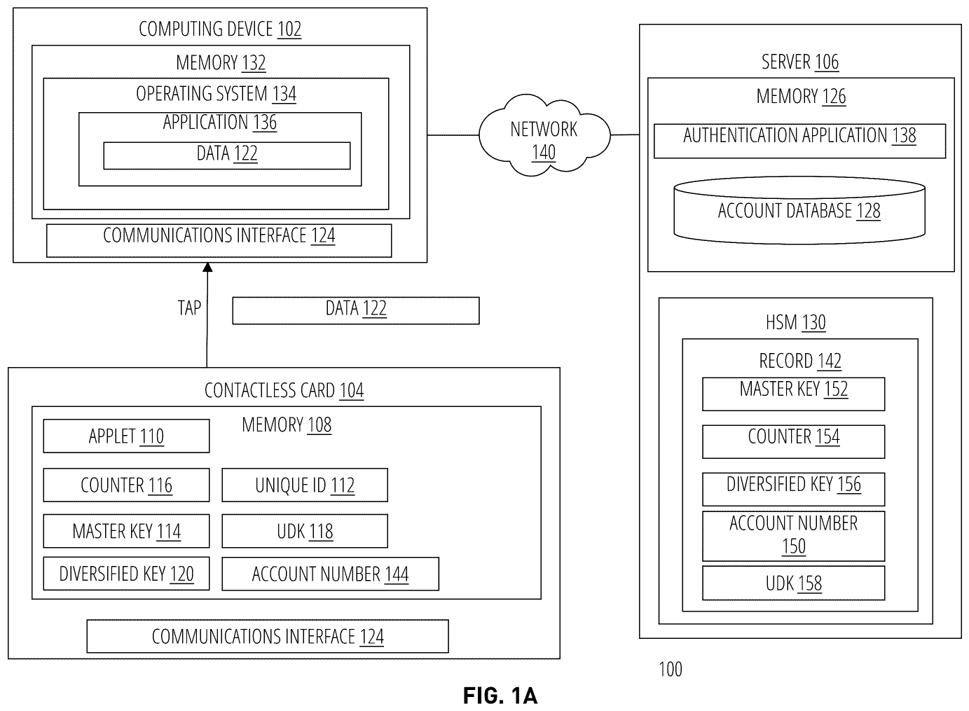

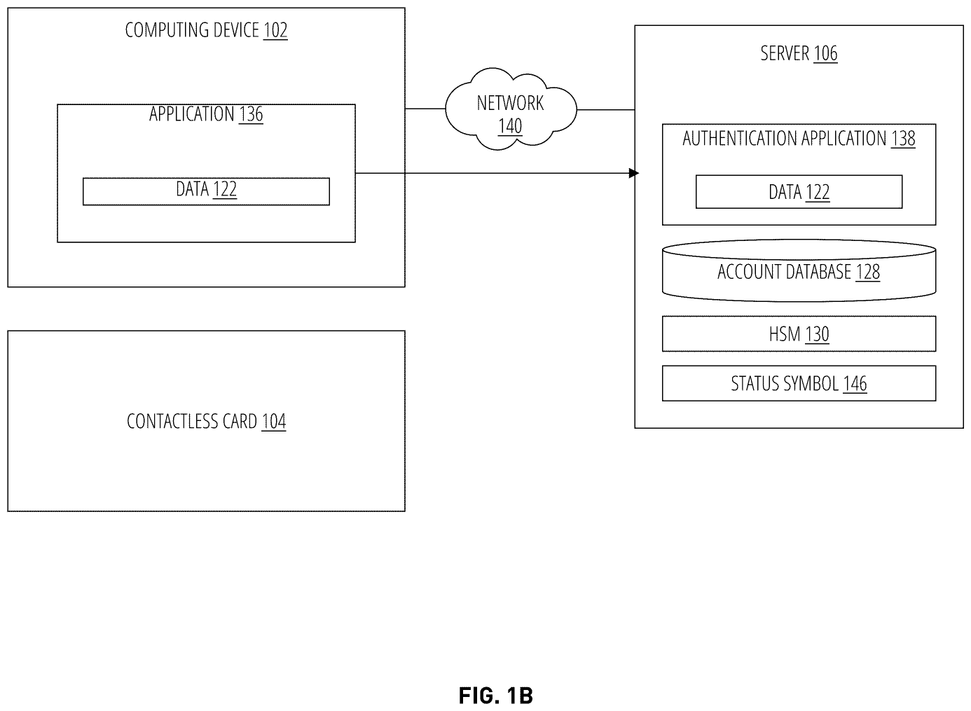

FIG. 1A depicts an exemplary computing architecture 100, also referred to as a system, consistent with disclosed embodiments. Although the computing architecture 100 shown in FIGS. 1A-1B has a limited number of elements in a certain topology, it may be appreciated that the computing architecture 100 may include more or less elements in alternate topologies as desired for a given implementation.

The computing architecture 100 comprises one or more computing devices 102, one or more servers 106, and one or more contactless cards 104. The contactless card 104 is representative of any type of card, such as a credit card, debit card, Automated Teller Machine (ATM) card, gift card, payment card, smart card, and the like. The contactless card 104 may comprise one or more communications interfaces 124, such as a radio frequency identification (RFID) chip, configured to communicate with a communications interface 124 (also referred to herein as a “card reader”, a “wireless card reader”, and/or a “wireless communications interface”) of the computing devices 102 via near-field communication (NFC), the Europay, Mastercard, and Visa (EMV) standard, or other short-range protocols in wireless communication. Although NFC is used as an example communications protocol herein, the disclosure is equally applicable to other types of wireless communications, such as the EMV standard, Bluetooth®, and/or Wi-Fi®.

The computing device 102 is representative of any number and type of computing device, such as smartphones, tablet computers, wearable devices, laptops, portable gaming devices, virtualized computing system, merchant terminals, point-of-sale systems, servers, desktop computers, and the like. A mobile device may be used as an example of the computing device 102, but should not be considered limiting of the disclosure. The server 106 is representative of any type of computing device, such as a server, workstation, compute cluster, cloud computing platform, virtualized computing system, and the like. Although not depicted for the sake of clarity, the computing device 102, contactless card 104, and server 106 each include one or more processor circuits, e.g., to execute programs, code, and/or instructions. The computing device 102 and the server 106 communicate with each other via a communication network 140, e.g., the Internet.

As shown, a memory 108 of the contactless card 104 includes an applet 110, a counter 116, one or more master keys 114, one or more diversified keys 120, a unique ID 112, a primary account number 144, and one or more Unique Derived Keys (UDKs) 118. The unique ID 112 may be any identifier that uniquely identifies the contactless card 104 and customer associated with the card. The Account number 144 may identify an account associated with the contactless card 104. The applet 110 is executable code configured to perform some or all of the operations described herein. In some instances, the contactless card 104 may include additional applets. For example, in some instances, the contactless card 104 may include a payment applet to provide payment services, e.g., via EMV, and an authentication applet to perform the authentication operations discussed herein. The counter 116 is a value maintained by the contactless card 104. The counter 116 may include a number that changes each time data is exchanged between the contactless card 104 and another device, such as the server 106 (and/or the contactless card 104 and the computing device 102). The counter 116, master keys 114, diversified keys 120, UDKs 118, Account number 144, and/or unique ID 112 are used to provide security in the system 100 as described in greater detail below. In some instances, the contactless card 104 may not include the master keys 114. The master keys 114 may be utilized at the time of manufacture to generate card master keys, e.g., UDKs 118, which may be utilized to generate diversified keys 120, e.g., session keys. In some embodiments, diversified keys 120 are generated each time data is exchanged with another device and are different from each other, i.e., new diversified keys 120 are generated each exchange.

In some instances, the contactless card 104 with the server 106 may utilize other encryption techniques, such that the contactless card 104 can securely provide data to the server 106 that can be authenticated. For example, system 100 can utilize a Fast Identity Online (FIDO) Alliance standard of encryption to securely communicate data between the devices. The contactless card 104 may be provisioned with a private key of a private/public pair and the server 106 may be provisioned with a public key to authenticate encrypted or signed data from the contactless card 104. In these instances, the authentication process can include a challenge and response process. For example, a device, such as computing device 102, can send a challenge to the contactless card 104, which is a unique request for authentication. The contactless card 104 generates a response, e.g., encrypted or signed data (challenge data) using the private key. The response is communicated to the server 106 via the computing device 102. The server 106 receives the response and authenticates it with the public key, i.e., verifies its authenticity.

In embodiments, the computing device 102 includes a number of components and devices. As shown, a memory 132 of the computing device 102 includes an instance of an operating system 134. Example operating systems include the Android®, iOS®, macOS®, Linux®, and Windows® operating systems. As shown, the operating system 134 includes an application 136. In some embodiments, a user may authenticate using authentication credentials to access certain features of the application 136. For example, the authentication credentials may include a username (or login) and password, biometric credentials (e.g., fingerprints, Face ID, etc.), and the like.

The application 136 may be used to create, manage, access, or otherwise use a social media account, a news-media outlet account, a blog, a podcast, a video log, a streaming account, a gaming account, a public relations account, a reviewer account, or any other type of user-account. Here, a user account is associated with a user profile that is accessible (e.g., viewable, shareable, addressable, etc.) by other users of the system. The other users may be from the general public or from a selectable group of users. The other users may or may not have their own accounts. The user profile is used by the owner of the user account or the owner's agent to provide, disseminate, broadcast, etc., information. The information may include text, images, videos, audio, uniform resource locations, links, hyperlinks, source code, scripts, digital files, or other content. The content may or may not include facts and/or opinions. The content may or may not be original. Henceforth, a user who publishes a post is called a “publisher.” The publisher can be the user account's owner or the owner's authorized agent.

Knowing that the information provided in a post via the user profile is indeed posted by the owner or the owner's authorized agent can be critical for other users. For example, knowing that the publisher's identity has been verified can be the difference between trusting and not trusting the information provided on the user profile. Alternatively, or in addition, the difference can be in how the information is perceived, e.g., news, satire, review, original work, advertisement, etc. Apart from human users, knowing that the identity of the publisher of a post has been verified can also be crucial for other machines, such as web search engines, artificial intelligence-based chatbots, etc. Based on the knowledge that the publisher of the post is verified (or not), the other machine may (or may not) include information from the post in that machine's analysis and/or results. In other words, the other machine may filter the information in the post based on whether the identity of the publisher of the post has been verified (or not). It should be noted that the “publisher” of the post may be a single person, a group of people, an organization, a delegated person(s), etc., or any other authorized user of the user account.

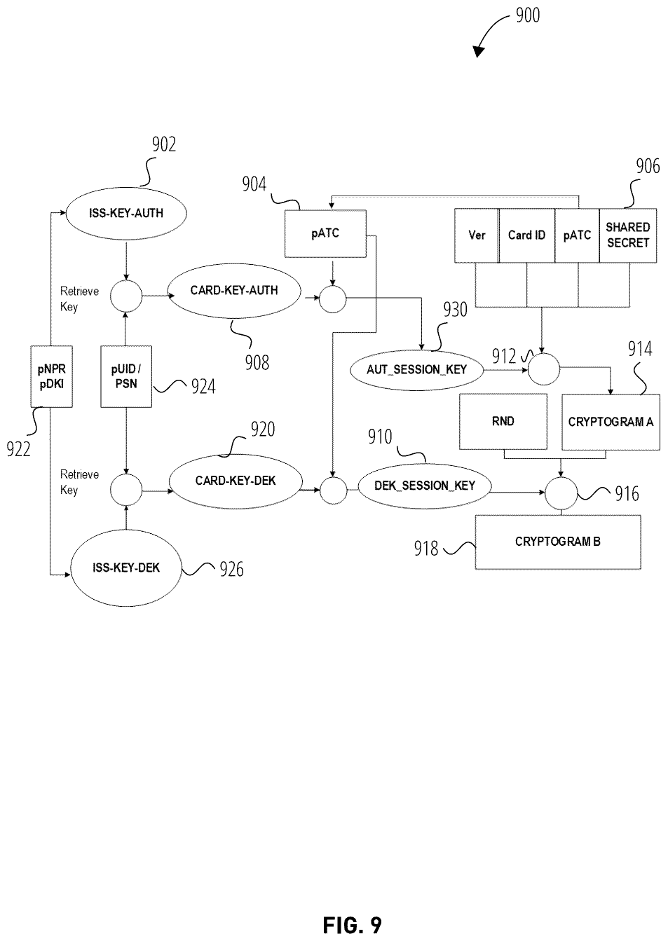

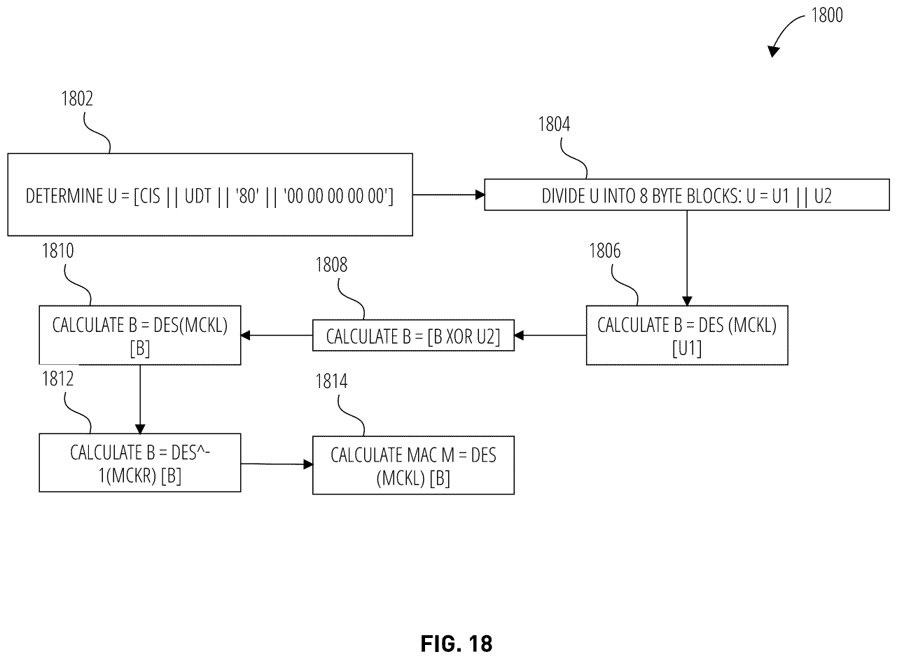

In the embodiment depicted in FIG. 1A, the user may authenticate themselves with the contactless card 104 when publishing information. In one example, the user may tap the contactless card 104 to the computing device 102 (or otherwise bring the contactless card 104 within communications range of the communications interface 124 of the device 102). The application 136 may receive a cryptogram 122, e.g., encrypted data, from the applet 110 of the contactless card 104. The cryptogram 122 may be generated based on any suitable cryptographic technique, e.g., FIDO standard, FIG. 9 and the corresponding text, FIG. 18 and corresponding, etc. In some embodiments, the cryptogram 122 may be based on the unique ID 112 or shared secret of the contactless card 104. In some embodiments, the applet 110 may generate the cryptogram 122 and an unencrypted identifier (e.g., the counter 116, the Account number 144, the unique ID 112, and/or any other unique identifier) as part of a data package communicated to the computing device 102. In at least one embodiment, the data package is an NFC Data Exchange Format (NDEF) file.

The computing device 102 may receive the cryptogram 122 and authenticate it. For example, the computing device 102 may send the cryptogram 122 to the server 106 to authenticate. In some embodiments, the application 136 may include with the cryptogram 122 additional verification data, such as information that indicates an identity of the publisher. The additional verification data may include a status symbol that is to be used as a badge on the post, in some cases. Alternatively, or in addition, the additional verification data may include a alphanumeric string, a hash key, or any other unique identifier indicative of the user's identity. In some embodiments, the additional verification data is based on biographical information, such as, name, age, location, birthdate, etc., of the publisher. Alternatively, or in addition, the additional verification data may include the publisher's account information, such as username, password, etc. The additional verification data may be stored by the application 136 on the computing device 102, in some embodiments.

As stated, the computing architecture 100 can be configured to implement key diversification to secure data, which may be referred to as a key diversification technique herein. Generally, the server 106 (or another computing device) and the contactless card 104 may be provisioned with the same master key 114 and/or card master keys (UDKs 118, 158). More specifically, each contactless card 104 is programmed with a distinct master key 114 that has a corresponding pair in the hardware security module (HSM) 130 of the server 106. For example, when a contactless card 104 is manufactured, one or more diversified key 120 may be generate from one or more unique master keys 114, e.g., issuer master keys and may be programmed into the memory 108 of the contactless card 104. Similarly, the unique master key 114 may be used to generated corresponding card master keys 158 stored in a record 142 in the HSM 130.

Furthermore, the diversified keys 120 may be diversified from the UDKs 118 via key generation techniques that takes, as input, a diversification factor, such as the counter 116, 154. In some embodiments, the diversification factor may be the unique ID 112 and Account number 144 of the contactless card 104. The UDKs 118, 158 may be stored in the contactless card 104 and server 106. The UDKs 118 may be kept secret from all parties other than the contactless card 104 and server 106, thereby enhancing the security of the system 100. Although depicted as being stored in the record 142, in some embodiments, the counter 116 and/or Account number 144 are not stored in the HSM 130. For example, the unique ID 112, counter 116, and Account number 144 may be stored in the account database 128.

In some embodiments, to generate the cryptogram 122, the applet 110 may provide the UDK 118, unique ID 112, and a diversification factor as input to a cryptographic algorithm, thereby producing a diversified keys 120, e.g., session keys. In some embodiments, the diversification factor is the counter 116. In other embodiments, the Account number 144 is the diversification factor. The diversified key 120 may then be used to encrypt data, such as the diversification factor (e.g., the counter 116 and/or the Account number 144) or other sensitive data (a version number, a card identifier, a shared secret, etc., see, e.g., FIG. 9). The applet 110 and the server 106 may be configured to encrypt the same type of data to facilitate the decryption and/or verification processing of a cryptogram.

As stated, the UDKs 118 of the contactless card 104 and server 106 may be used in conjunction with the counters 116 to enhance security using key diversification. As stated, the counters 116, 154 includes synchronized values between the contactless card 104 and server 106. The counter 116 may include a number that changes each time data is exchanged between the contactless card 104 and the server 106 (and/or the contactless card 104 and the computing device 102). When preparing to send data (e.g., to the server 106 and/or the device 102), the applet 110 of the contactless card 104 may increment the counter 116. The applet 110 of the contactless card 104 may then provide the UDK 118, unique ID 112, and counter 116 as input to a cryptographic algorithm, which produces a diversified key 120 as output. The cryptographic algorithm may include encryption algorithms, hash-based message authentication code (HMAC) algorithms, cipher-based message authentication code (CMAC) algorithms, and the like. Non-limiting examples of the cryptographic algorithm may include a symmetric encryption algorithm such as 3DES or AES107; a symmetric HMAC algorithm, such as HMAC-SHA-256; and a symmetric CMAC algorithm such as AES-CMAC. Examples of key diversification techniques are described in greater detail in U.S. patent application Ser. No. 16/205,119, filed Nov. 29, 2018. The aforementioned patent application is incorporated by reference herein in its entirety. In some embodiments, the Account number 144 is used as input to the cryptographic algorithm instead of the counter 116 to generate the diversified key 120, e.g., by encrypting the UDK 118, unique ID 112 and Account number 144.

The applet 110 may then encrypt data using the diversified key(s) 120 and the data as input to the cryptographic algorithm. For example, encrypting the unique ID 112 with the diversified key 120 may result in an encrypted unique ID 112 (e.g., a cryptogram 122). As stated, the applet 110 and the server 106 may be configured to encrypt the same data.

In some embodiments, two diversified keys 120 may be generated, e.g., based on one or more portions of the input to the cryptographic function. In some embodiments, the two diversified keys 120 are generated based on two distinct master keys 114, two distinct UDKs 118, the unique ID 112, and the counter 116 (or the Account number 144). In such embodiments, a message authentication code (MAC) is generated using one of the diversified keys 120, and the MAC may be encrypted using the other one of the diversified keys 120. The MAC may be generated based on any suitable data input to a MAC algorithm, such as sensitive data, the unique ID 112, the counter 116, and/or the Account number 144. More generally, the applet 110 and the server 106 may be configured to generate the MAC based on the same data. In some embodiments, the cryptogram 122 is included in a data package such as an NDEF file. The application 136 may then read the data package including cryptogram 122 via the communications interface 124 of the computing device 102.

FIG. 1B depicts an embodiment where the application 136 transmits the cryptogram 122 or encrypted/signed data to the server 106. The server 106 may provide the cryptogram 122 to the authentication application 138 and/or the HSM 130 for verification based at least in part on the instance of the master key 114 and/or UDK 118 stored by the server 106. In some embodiments, the authentication application 138 and/or the HSM 130 may identify the UDK 118 (or master key 114) and counter 116 using the unencrypted unique ID 112 provided to the server 106. In examples where the Account number 144 is used to generate the cryptogram 122, the server 106 may identify the Account number 144 in the account database 128 and/or HSM 130 using the unencrypted unique ID 112. In some examples, the authentication application 138 may provide the UDK 118, unique ID 112, and/or counter 116, as input to the cryptographic function of the HSM 130, which produces one or more diversified keys 120 as output. In other embodiments, the server encrypts the UDK 118, unique ID 112, and/or Account number 144 to generate the diversified keys 120. The resulting diversified keys 120 may correspond to the diversified keys 120 of the contactless card 104, which may be used to decrypt the cryptogram 122 and/or verify the MAC once decrypted. For example, the server 106 may generate a MAC based on the same data as the applet 110, e.g., the sensitive data, the unique ID 112, the counter 116, and/or the Account number 144. If the MAC generated by the server 106 matches the decrypted MAC in the cryptogram 122, the server 106 may verify or otherwise authenticate the cryptogram 122.

Regardless of the decryption technique used, the authentication application 138 and/or the HSM 130 may successfully decrypt the cryptogram 122 and verify the MAC, thereby verifying or authenticating the cryptogram 122. If the decryption and/or MAC verification is successful, the authentication application 138 and/or the HSM 130 may generate a notification indicative of the successful authentication. In some embodiments, the notification may include a status symbol 146 indicative of the user-account's owner's identity being successfully verified. In some embodiments, the status symbol 146 is based on additional verification data from the application 136. For example, the additional verification data includes a selection of the status symbol 146 by the owner of the user-account. For example, the owner can select the status symbol 146 to be a badge that includes one or more of text, icon, image, animation, video, audio, user-interface element, or any other audio/visual indicator, or a combination thereof.

Returning to the decryption, if the authentication application 138 is unable to decrypt the cryptogram 122 (and/or is unable to verify the MAC) the authentication application 138 does not validate the cryptogram 122. In such an example, the authentication application 138 determines to refrain from generating a status symbol 146. The authentication application 138 may transmit an indication of the failed decryption and/or verification to the computing device 102 or any other device seeking the owner's verification.

In some embodiments the authentication application 138 transmits the status symbol 154 to the computing device 102. As shown, the application 136 may store the status symbol 154 (in the memory 132 and/or a non-volatile storage, not pictured for the sake of clarity). The application 136 may hash, encrypt, or otherwise obfuscate the status symbol 154. The application 136 may protect the status symbol 154 with authentication controls, such as a username and/or password, biometric credentials, etc. In addition, and/or alternatively, the application 136 may require cryptogram decryption and/or verification using the contactless card 104 to access the status symbol 154 (e.g., the contactless card 104 generates a cryptogram which is verified by the server 106 as described herein). In addition, in some embodiments, the application 136 may require the user (i.e., owner) to provide the status key 152 to access the status symbol 154 and/or perform operations using the status symbol 154. More generally, the application 136 may provide a variety of interfaces to access, use, or otherwise manage the status symbol 154. In some embodiments, the status symbol 154 is transmitted to the computing device 102 by the server 106 as part of or in conjunction with the notification of success (or failure) of the authentication of the user's identity using the cryptogram 122.

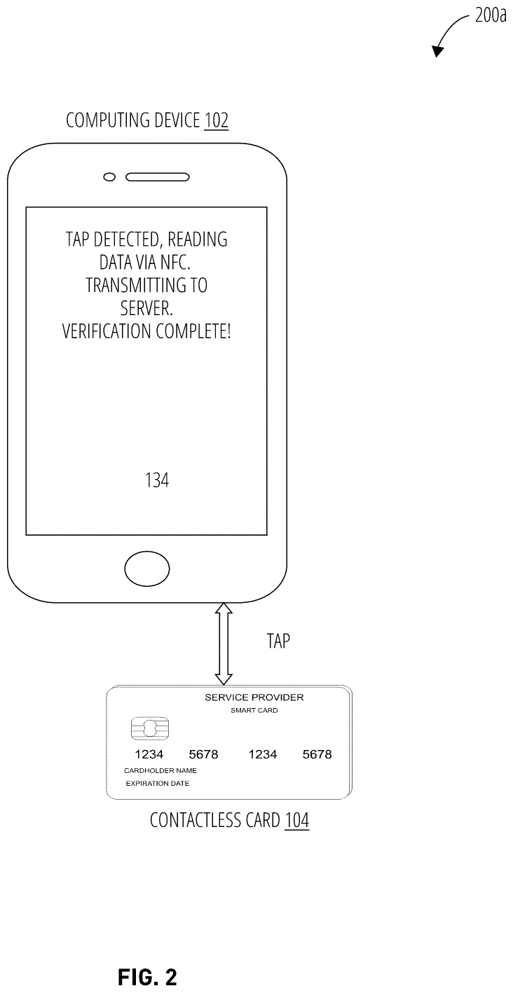

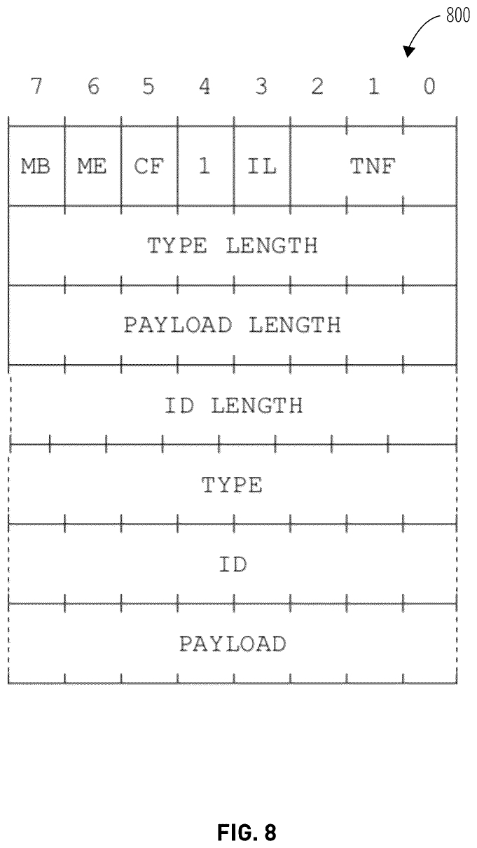

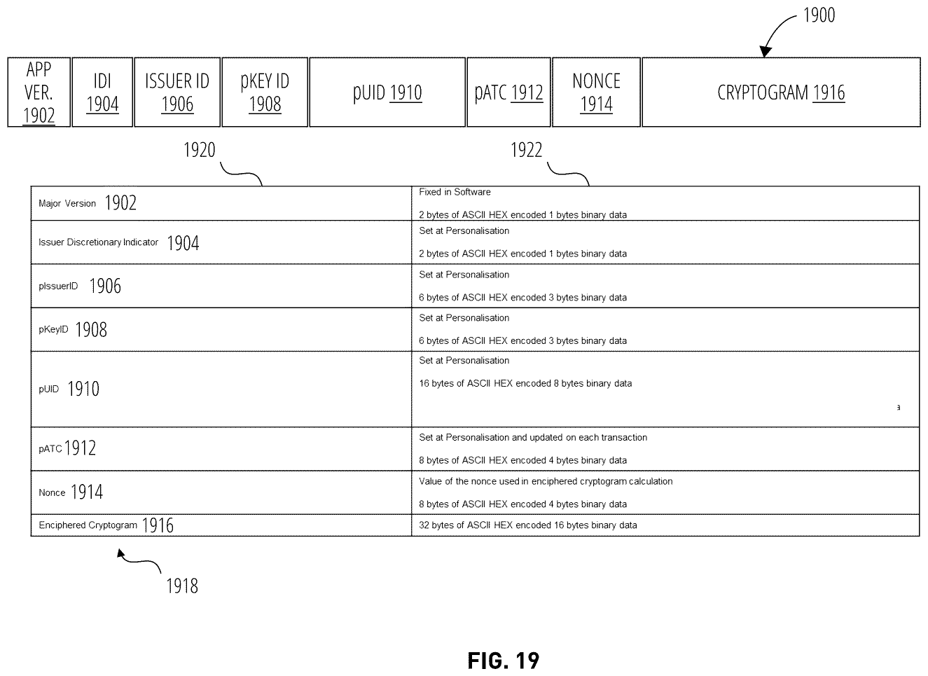

FIG. 2 is a schematic 200a of a scenario illustrating an embodiment where a contactless card 104 is tapped to a computing device 102, e.g., to recover the cryptogram 122, encrypted data, signed data, etc. As stated, when the contactless card 104 is tapped to the computing device 102, the applet 110 may generate a cryptogram (e.g., the cryptogram 122) or other structure. The cryptogram 122 and any other data (e.g., unencrypted unique ID 112) may be included in a data package, such as an NDEF file, that is read by the computing device 102. The computing device 102 may then transmit the cryptogram 122 to the server 106 for verification (e.g., decryption and/or MAC verification) as described herein. FIG. 8 and FIG. 19 illustrate examples of data packet configurations that may be communicated in accordance with embodiments discussed herein.

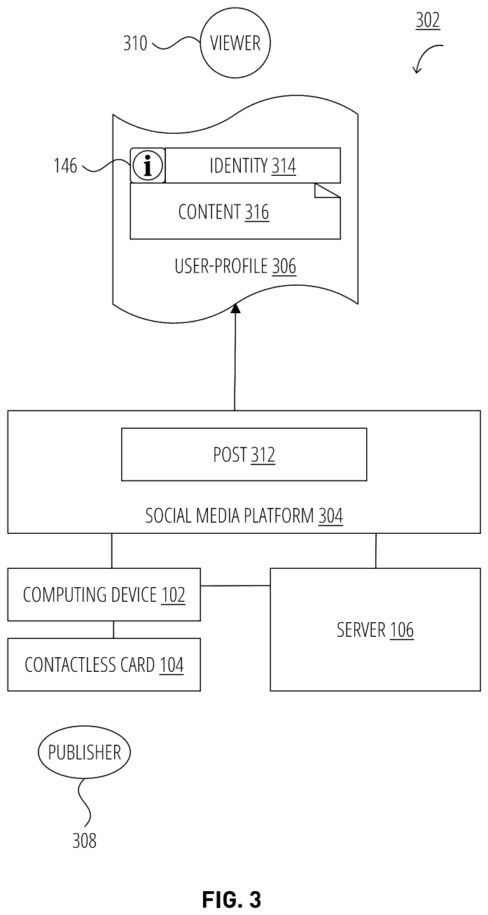

FIG. 3 depicts another illustration 302 of the system 100 according to an embodiment. In the illustration 302, the computing device 102, the contactless card 104, and the server 106 are used to verify the identity of the publisher 308 of a post 312 of a social media platform 304. In some embodiments, the social media platform 304 can be another computing server, separate from the server 106. The social media platform 304 and the server 106 may communicate with each other via the network 140 (not repeated). The server 106 facilitates verifying the identity of the publisher 308. The social media platform 304 facilitates the publisher 308 of the post 312 to disseminate content 316, i.e., information, to one or more viewers 310 via the post 312. Alternatively, or in addition, the social media platform 304 facilitates the viewers 310 to access the content 316 or information published by the publisher 308 via the post 312 on the social media platform 304.

The user-profile 306 can be viewable, accessible, addressable, and/or shareable by one or more viewers 310. The user-profile 306 can be a webpage or a portion of a webpage that is digitally accessible to consume content 316 posted on the user-profile 306. For example, the user-profile 306 can be a blog, a microblog, a social media page, a podcast, a video-stream, a gaming stream, a news/media outlet page, or any other such information dissemination outlet. The content 316 can include text, images, videos, sounds, links, digital files, machine-readable codes, scripts, user-interface elements, and any other type of digital content or a combination thereof. The user-profile 306 can provide the content 316 in human and/or machine readable form. The user-profile 306, apart from the content 316 provided by the publisher 308, includes an identity 314 of the publisher 308. The identity 314 can be a name, a username, a screen name, a designation, a business name, or any other such identifier. The user-profile 306 can also include an additional portions (not shown), such as but not limited to, a photo, a tagline, etc., associated with the publisher 308. Further, the user-profile 306 includes the status symbol 146 that indicates whether the identity 314 of the publisher 308 has been verified and/or authenticated.

The status symbol 146 can be an icon, a text, an image, an animation, a video, an audio, a machine-readable code, or any other indicator to inform the viewer 310 that the identity 314 of the publisher 308 has been authenticated successfully, or in other words, that it has been verified that the publisher 308 is who they say they are. In some embodiments, the status symbol 146 can include a visual attribute, such as a color, a shape, a dimension, etc., that further indicates a level of the verification. For example, the level of verification can be based on a duration since the publisher 308's identity 314 has been verified. For example, a green icon may be used as the status symbol 146 to indicate that the latest verification has been very recent, such as in the past 72 hours; a blue icon may be used as the status symbol 146 to indicate that the latest verification has been in the past month; and a red icon may be used as the status symbol 146 to indicate that the latest verification has been before a year. It is understood that above is just one possible example, and that several other variations can be implemented in other embodiments.

In some embodiments, the status symbol 146 can be based on a selection made by the publisher 308. For example, the social media platform 304 may provide a list of status symbols 146 to choose from to indicate that an authentication (i.e., verification) of the identity 314 has been successfully completed. In some embodiments, the publisher 308 may add a new status symbol 146 of choice to the list of status symbols 146. The publisher 308 may select one from the list of status symbols 146. The chosen status symbol 146, or a choice of the status symbol 146 (e.g., index of the status symbol 146 in the list) may be stored in the application 136 and/or the contactless card 104 in some embodiments.

In some embodiments, the status symbol 146 may indicate that the identity 314 of the publisher 308 is not verified. This can be in response to a failed verification or authentication of the identity 314. Alternatively, or in addition the status symbol 146 indicates that the publisher 308 does not have a verified/registered account with the social media platform 304, and hence an authentication was not performed. Accordingly, in some embodiments, there can be at least three types of status symbols—a first status symbol 146 indicative that the identity 314 of the publisher 308 is successfully verified; a second status symbol 146 indicative that the identity 314 of the publisher 308 failed verification; and a third status symbol 146 indicative that the identity of the publisher 308 cannot be verified. The first status symbol 146 can further have different levels of verification as described herein. The third status symbol 146 can include an explanation of why the verification was not conducted, e.g., lack of a post 312, non-payment of verification or other fees, etc.

The viewer 310 is a consumer of the content 316 on the user-profile 306. The viewer 310 may or may not have a user-account on the social media platform 304. In some embodiments, the viewer 310 may be a human. The human viewer 310 may determine whether to trust the information in the content 316 on the user-profile 306 based on whether the identity 314 of the publisher 308 has been verified and the user-profile 306 indicates as such via the status symbol 146. In some embodiments, the viewer 310 may be a machine, e.g., a web search engine, a chatbot, an artificial-intelligence based decision machine, etc. The machine viewer 310 may determine whether to use the information on the user-profile 306 in its analysis and/or results based on whether the identify of the publisher 308 has been verified and the user-profile 306 indicates as such via the status symbol 146. It is understood that although only one viewer 310 is depicted, several viewers 310 can consume the content 316 sequentially or simultaneously. The viewers 310 can include a combination of human and machine users.

In some embodiments, the identity 314 of the publisher 308 depicted on the user-profile 306 can include meta-information in addition to the status symbol 146. The meta-information can include but is not limited to a geographic location where the contactless card 104 is tapped (or used) by the computing device 102 for the identity verification. The geographic location can specify a city, state, country, zip/pin code, coordinates, or any other location identification. The meta-information can further include a association-status of the publisher 308 in relation to the user-profile 306. For example, the association-status can specify if the publisher 308 is an owner or an agent of the user-profile 306. In some embodiments, depending on the association-status, the status symbol 146 may be different.

While the social media platform 304 and the server 106 used to authenticate the identity 314 are shown as separate devices in FIG. 3, it is understood that, in some embodiments, the same device can include the social media platform 304 and the server 106, both. Further, in some other embodiments, the contactless card 104 used to authenticate the identity 314 can be another computing device, such as a mobile phone, a wearable device, a tablet computer, or any other type of computing device that includes a processing circuitry that facilitates performing one or more operations described herein.

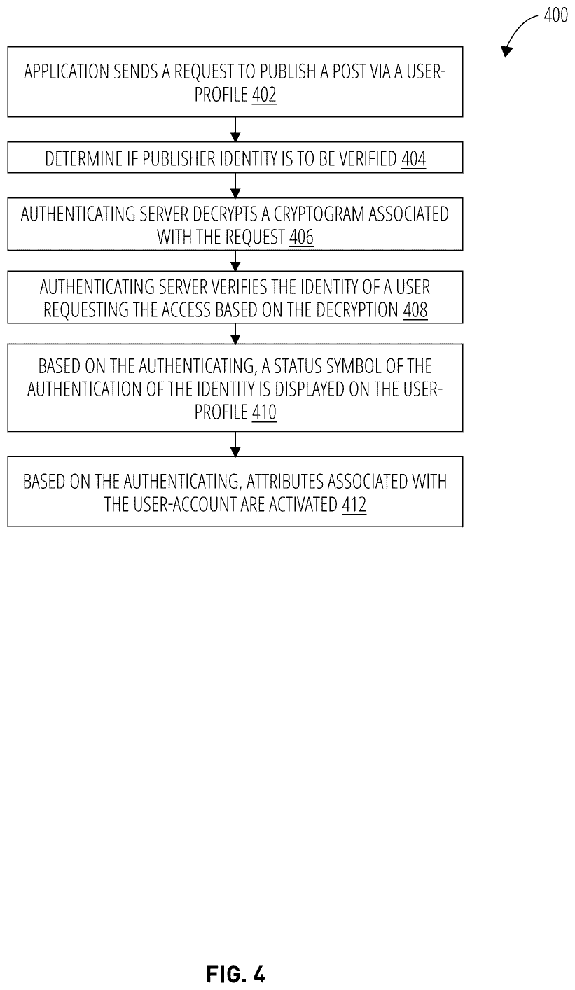

FIG. 4 illustrates an embodiment of a logic flow, or routine 400. In block 402, the server 106 receives, from the application 136, a request to publish a post 312 via a user-profile 306. The request is initiated by the publisher 308 via the computing device 102.

For example, consider that the social media platform 304 is a website, such as Threads®. The publisher 308 desires to publish the post 312 on the microblogging website using the computing device 102. Hence, the publisher 308 opens the application 136 (e.g., a mobile application for the computing device 102) and sends a first request to login to the user-account on the social media platform 304. The first request can include a username, password, or other login credentials associated with the publisher 308. In some embodiments logging into the application 136 may include a multi-factor authentication. In some instances, the publisher 308 may utilize the contactless card 104 to authenticate themselves to log into the application 136 itself as single or multi-factor authentication.

Once logged in, the publisher 308 can create the post 312 using one or more user interfaces provided by the application 136. Alternatively, or in addition, the publisher 308 can include content 316 from other applications of the computing device 102 to create the post 312.

At block 404, prior to publishing the post 312, the routine 400 includes determining whether the identity 314 of the publisher 308 is to be verified. The determination can be performed by the server 106, the application 136, and/or the social media platform 304 on which the post 312 is requested to be published.

In some embodiments, the determination is based on the content 316 of the post 312. For example, a trained machine learning model is used to determine a sensitivity of the post 312. The machine learning model performs natural language processing, image processing, and other syntactic and semantic analysis of the content 316. Based on the syntactic and semantic analysis, the content 316 may be assigned a sensitivity score in some embodiments. For example, the sensitivity score is a numerical score within a predetermined range, such as 1 through 5, where the higher the score, higher the sensitivity of the content 316. Different scoring values or ranges are possible in other embodiments. Alternatively or in addition, the content 316 may be classified into one or more sensitivity categories, such as low, medium, and high. Additional, fewer, or different categories are possible in other embodiments.

In some embodiments, based on the sensitivity score being above a predetermined threshold (e.g., 3, 4, etc.) or the sensitivity category being one of predetermined categories (e.g., high, medium, etc.), it is determined if the identity of the publisher 308 is to be verified.

Alternatively, or in addition, the social media platform 304 receives the first request and detects that the user-account is associated with a verification status. The verification status can be based on a verification service offered by the social media platform 304, and the user-account opting to use the verification service. Alternatively, or in addition, the verification service may be based on the user-account being associated with a public figure, such as an elected officer of a government, a public officer, a government officer, an official spokesperson of a government office or agency, etc. Several other conditions may be used to determine which user-accounts have a verification service. The verification service is to authenticate the identity of the publisher 308 requesting to publish a post 312 via the user-account.

Upon determination that the verification service is to be used (i.e., identity 314 of the publisher 308 is to be verified) for the post 312 being published, the social media platform 304 can instruct the application 136 to obtain and transmit information to conduct such an authentication, e.g., using a cryptogram 122, encrypted data, signed data, etc. In some embodiments, the request to publish the post 312 includes the cryptogram 122 generated by the contactless card 104.

Alternatively, upon determination that the verification service is to be used (i.e., identity 314 of the publisher 308 is to be verified) for the post 312 being requested, the social media platform 304 can instruct the server 106 to authenticate the identity 314. The server 106 may provide the verification service by providing an API, for example, that the social media platform 304 accesses. Upon receiving the instruction to authenticate the identity 314 of the publisher 308, the server 106 may establish a direct communication with the computing device 102, or continue to communicate with the computing device 102 via the social media platform 304. The social media platform 304 may facilitate to establish the direct communication between the computing device 102 and the server 106 in some embodiments. Regardless of which technique is used, the server 106 instructs the computing device 102 to obtain and transmit information to conduct such an authentication, e.g., the cryptogram 122.

In response to the instruction from the social media platform 304 or the server 106, the application 136 displays a notification (via a display of the computing device 102) for the user to bring the contactless card 104 in the predetermined vicinity of the computing device 102 to obtain the authentication information from the contactless card 104. (E.g., see FIG. 2). The computing device 102, and in turn the application 136, recovers the cryptogram 122 from the contactless card 104. In some embodiments, the application 136 forwards a second request to publish the post 312 with the cryptogram 122. In some embodiments, only the cryptogram 122 is transmitted by the application 136.

In some embodiments, in response to the instruction from the social media platform 304 or the server 106 to obtain the cryptogram 122, the application 136 communicates with a second application of the computing device 102. The second application is associated with the contactless card 104 and may be provided by the issuer of the contactless card 104. For example, if the contactless card 104 is a bank card, the second application is provided by the bank that issued the contactless card 104. The application 136 communicates with the second application to obtain the cryptogram 122 from the contactless card 104. For example, the application 136 sends, using an application programming interface (API) of the second application, a request for the cryptogram 122. The second application, in response, displays a notification (via a display of the computing device 102) for the user to bring the contactless card 104 in the predetermined vicinity of the computing device 102 to obtain the authentication information from the contactless card 104. (E.g., see FIG. 2). The computing device 102, and in turn the second application, recovers the cryptogram 122 from the contactless card 104. The second application sends the cryptogram 122 to the application 136 as a response to the API request.

As described herein, the cryptogram 122 can be based on a one or more parameters from the counter 116, unique ID 112, master key 114, UDK 118, diversified key 120, and the Account number 144 associated with the contactless card 104. In some embodiments, the request can include the owner's 308 selection of one or more settings associated with the verification service, e.g., whether to verify the post 312 or not.

In some embodiments, the application 136 sends the first request itself with the cryptogram 122 by determining if the verification service is to be used, without having the social media platform 304 and/or the server 106 having to do so. The cryptogram 122 is obtained from the contactless card 104 as described herein.

In block 406, the server 106 decrypts the cryptogram 122 based on the one or more parameters associated with the contactless card 104. In block 408, the server 106 authenticates, based on the decryption, identity 314 of the publisher 308 making the request to access the post 312. The authentication is performed using one or more techniques described herein and success of the authentication depends on the decrypted content from the cryptogram 122 matching information stored on the server 106.

In block 410, in response to the authentication being successful, the social media platform 304 grants the requesting user access to the post 312 and displays the status symbol 146 on the user-profile 306 of the post 312. The status symbol 146 indicates that the identity 314 of the publisher 308 has been successfully authenticated. In the embodiments where the server 106 verifies the identity 314, the server 106 instructs the social media platform 304 to display the status symbol 146. As described herein, the status symbol 146 may vary based on the owner's 308 selection and other parameters. Alternatively, in block 410, in response to the authenticating being unsuccessful, the social media platform 304 does not grant access to the post 312. After at least a predetermined number of unsuccessful verification attempts within a predetermined duration, the post 312 may be locked. In some embodiments, the social media platform 304 changes the status symbol 146 to indicate that the post 312 has been locked in such cases.

In some embodiments, the verification of the identity 314 is not performed (in block 408). For example, the verification is not performed because the publisher 308 has opted not to be verified. In such embodiments, the server 106 and/or the social media platform 304 may not request the cryptogram 122 from the computing device 102. In this case, the status symbol 146 of the user-profile 306 is set to display that the post 312 is unverified.

In this manner, the status symbol 146 of the user-profile 306 is updated to indicate whether the identity 314 of the publisher 308 of the post 312 has been verified, and whether such verification was successful.

In some embodiments, the application 136 sends, to the social media platform 304, meta-information associated with the verification. Alternatively, or in addition, the server 106 sends the meta-information to the social media platform 304. In some embodiments, the meta-information may be provided based on successful verification of the identity of the publisher 308. The status symbol 146 includes the meta-information in some embodiments. Alternatively, the status symbol 146 includes a user-interface element (e.g., icon, link, etc.) that is accessible to display the meta-information.

In some embodiments, in the block 412, the social media platform 304 activates one or more attributes associated with the post 312 based on the authentication. The one or more attributes include but are not limited to amount of memory storage, access to one or more account functions, and access to one or more account databases available to the post 312. In some embodiments, a first post 312 with a verified owner's identity 314 may have access to certain privileges that a second post 312 with an unverified owner's identity 314 may not. For example, the verified first post 312 may have larger memory and/or storage than the unverified second post 312; the verified first post 312 may have more computing resources (e.g., processing power, graphics processing unit (GPU), scripts, artificial intelligence engine, etc.) than the unverified second post 312; and the verified first post 312 may have additional database access (e.g., images, contact lists, etc.) than the unverified second post 312. Additional and/or different benefits may be conferred by the social media platform 304 to the verified post 312 in other embodiments.

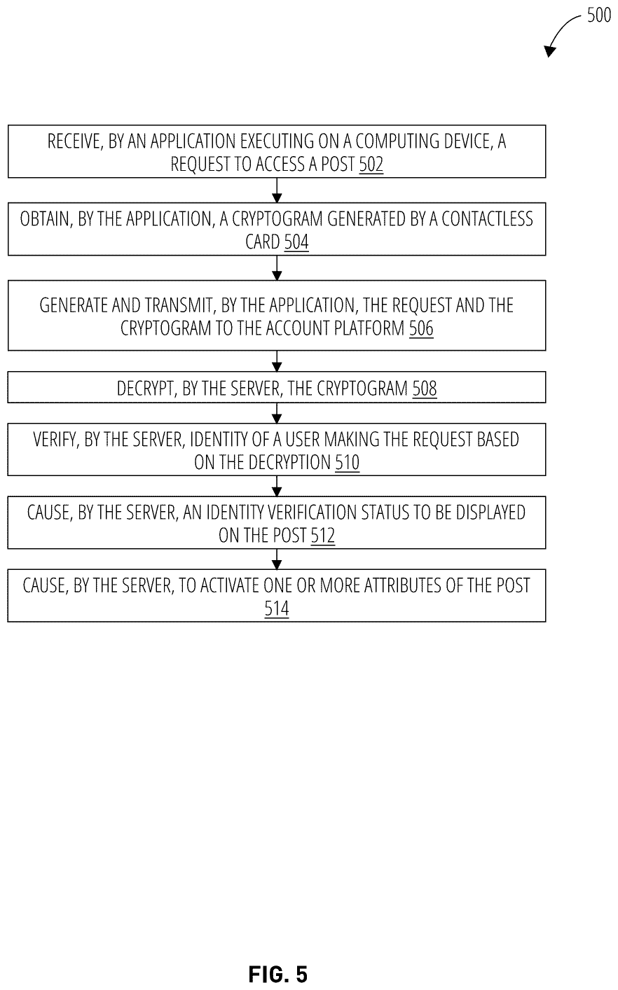

FIG. 5 illustrates an embodiment of a logic flow, or a routine 500. In block 502, the application 136 on the computing device 102 receives a request from a user to publish the post 312 associated with the social media platform 304. The request to publish may include a request to add, edit, or delete content 316 to the user-profile 306, a request to change one or more settings of the post 312, or any other such request associated with the post 312.

In block 504, the application 136, in response, obtains the cryptogram 122 from the contactless card 104. The application 136 may obtain the cryptogram 122 by instructing the user to bring the contactless card 104 within a NFC range of the computing device 102. The application 136 instructs the contactless card 104 to generate the cryptogram 122 once the contactless card 104 is within the range. The contactless card 104 generates the cryptogram 122 as described herein. The application 136 reads the cryptogram 122 from the contactless card 104. Alternatively, the contactless card 104 transmits the cryptogram 122 to the computing device 102. The application 136 obtains the cryptogram 122 from the contactless cards 104 in response to receiving a request to verify the identity of the user from the social media platform 304, in some embodiments. (See block 404).

In block 506, the application 136 generates and transmits a request to access the post 312, where the request includes the cryptogram 122. The request is transmitted to the social media platform 304 or the server 106 for verifying the identity 314 of the user. In block 508, the server 106 decrypts the cryptogram 122. In block 510, the server 106 verifies the identity 314 of the user based on the decryption. For example, if the decrypted content of the cryptogram 122 from the contactless card 104 matches the stored and or computed content on the server 106, the verification is deemed to be successful. In the case of mismatch, the verification is deemed to be unsuccessful.

In block 512, a status symbol 146 is displayed on the post 312 based on the verification being successful or unsuccessful. In the case of successful verification, the post 312 is updated to display the status symbol 146 that indicates that the identity 314 has been verified. In some embodiments, in the case of unsuccessful verification, the post 312 is updated to display the status symbol 146 that indicates that the identity 314 has been not verified. Alternatively, in some embodiments, in the case of unsuccessful verification, the post 312 is updated to remove or inactivate any existing status symbol 146 from the post 312 and further bypass displaying any status symbol 146 on the post 312.

In block 514, one or more attributes of the post 312 are activated based on the verification of the identity 314. The one or more attributes include but are not limited to amount of memory storage, access to one or more account functions, and access to one or more account databases available to the post 312. In some embodiments, a first post 312 with a verified owner's identity 314 may have access to certain privileges that a second post 312 with an unverified owner's identity 314 may not. For example, the verified first post 312 may have larger memory and/or storage than the unverified second post 312; the verified first post 312 may have more computing resources (e.g., processing power, GPU, scripts, AI, etc.) than the unverified second post 312; and the verified first post 312 may have additional database access (e.g., images, contact lists, etc.) than the unverified second post 312. Additional and/or different benefits may be conferred by the social media platform 304 to the verified post 312 in other embodiments.

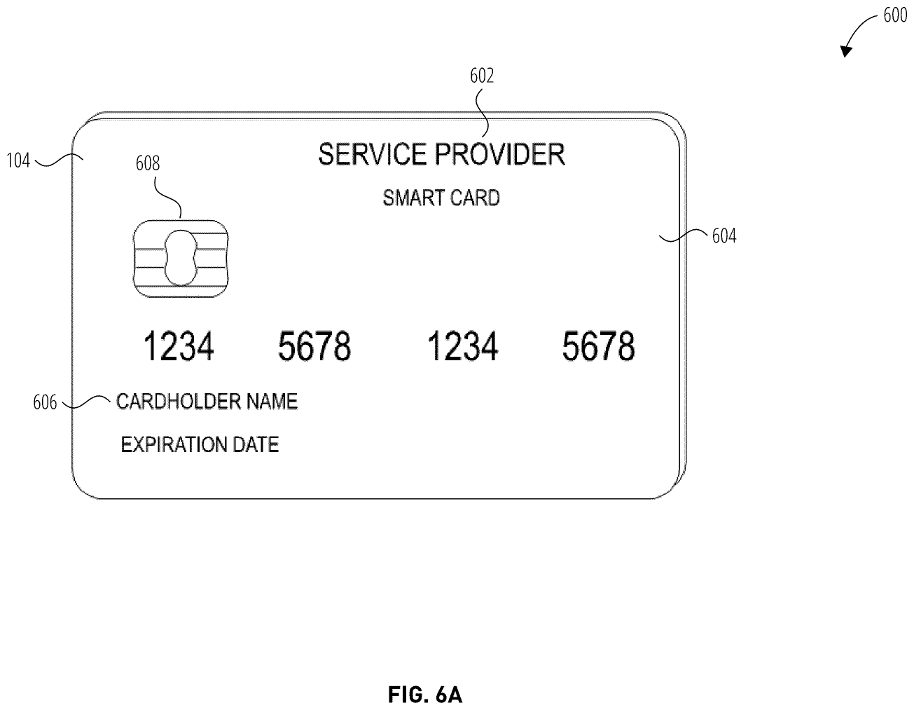

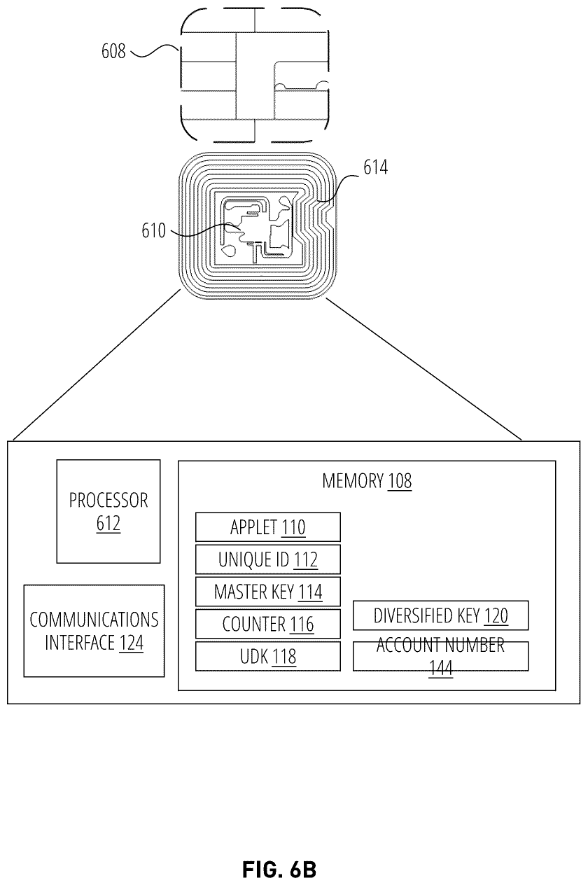

FIG. 6A is a schematic 600 illustrating an example configuration of a contactless card 104, which may include a payment card, such as a credit card, debit card, or gift card, issued by a service provider as displayed as service provider indicia 602 on the front or back of the contactless card 104. In some examples, the contactless card 104 is not related to a payment card, and may include, without limitation, an identification card. In some examples, the transaction card may include a dual interface contactless payment card, a rewards card, and so forth. The contactless card 104 may include a substrate 604, which may include a single layer or one or more laminated layers composed of plastics, metals, and other materials. Exemplary substrate materials include polyvinyl chloride, polyvinyl chloride acetate, acrylonitrile butadiene styrene, polycarbonate, polyesters, anodized titanium, palladium, gold, carbon, paper, and biodegradable materials. In some examples, the contactless card 104 may have physical characteristics compliant with the ID-1 format of the ISO/IEC 7816 standard, and the transaction card may otherwise be compliant with the ISO/IEC 14443 standard. However, it is understood that the contactless card 104 according to the present disclosure may have different characteristics, and the present disclosure does not require a transaction card to be implemented in a payment card.

The contactless card 104 may also include identification information 606 displayed on the front and/or back of the card, and a contact pad 608. The contact pad 608 may include one or more pads and be configured to establish contact with another client device, such as an ATM, a user device, smartphone, laptop, desktop, or tablet computer via transaction cards. The contact pad may be designed in accordance with one or more standards, such as ISO/IEC 7816 standard, and enable communication in accordance with the EMV protocol. The contactless card 104 may also include processing circuitry, antenna and other components as will be further discussed in FIG. 6B. These components may be located behind the contact pad 608 or elsewhere on the substrate 604, e.g. within a different layer of the substrate 604, and may electrically and physically coupled with the contact pad 608. The contactless card 104 may also include a magnetic strip or tape, which may be located on the back of the card (not shown in FIG. 6A). The contactless card 104 may also include a Near-Field Communication (NFC) device coupled with an antenna capable of communicating via the NFC protocol. Embodiments are not limited in this manner.

As illustrated in FIG. 6B, the contact pad 608 of contactless card 104 may include processing circuitry 610 for storing, processing, and communicating information, including a processor 612, a memory 108, and one or more communications interface 124. It is understood that the processing circuitry 610 may contain additional components, including processors, memories, error and parity/CRC checkers, data encoders, anticollision algorithms, controllers, command decoders, security primitives and tamperproofing hardware, as necessary to perform the functions described herein.

The memory 108 may be a read-only memory, write-once read-multiple memory or read/write memory, e.g., RAM, ROM, and EEPROM, and the contactless card 104 may include one or more of these memories. A read-only memory may be factory programmable as read-only or one-time programmable. One-time programmability provides the opportunity to write once then read many times. A write once/read-multiple memory may be programmed at a point in time after the memory chip has left the factory. Once the memory is programmed, it may not be rewritten, but it may be read many times. A read/write memory may be programmed and re-programed many times after leaving the factory. A read/write memory may also be read many times after leaving the factory. In some instances, the memory 108 may be encrypted memory utilizing an encryption algorithm executed by the processor 612 to encrypted data.

The memory 108 may be configured to store one or more applet 110, one or more counters 116, a unique ID 112, the master key 114, the UDK 118, diversified key 120, and the Account number 144. The one or more applets 110 may comprise one or more software applications configured to execute on one or more contactless cards 104, such as a Java® Card applet. However, it is understood that applets 110 are not limited to Java Card applets, and instead may be any software application operable on contactless cards or other devices having limited memory. The one or more counters 116 may comprise a numeric counter sufficient to store an integer. The unique ID 112 may comprise a unique alphanumeric identifier assigned to the contactless card 104, and the identifier may distinguish the contactless card 104 from other contactless cards 104. In some examples, the unique ID 112 may identify both a customer and an account assigned to that customer.

The processor 612 and memory elements of the foregoing exemplary embodiments are described with reference to the contact pad 608, but the present disclosure is not limited thereto. It is understood that these elements may be implemented outside of the contact pad 608 or entirely separate from it, or as further elements in addition to processor 612 and memory 108 elements located within the contact pad 608.

In some examples, the contactless card 104 may comprise one or more antenna(s) 614. The one or more antenna(s) 614 may be placed within the contactless card 104 and around the processing circuitry 610 of the contact pad 608. For example, the one or more antenna(s) 614 may be integral with the processing circuitry 610 and the one or more antenna(s) 614 may be used with an external booster coil. As another example, the one or more antenna(s) 614 may be external to the contact pad 608 and the processing circuitry 610.

In an embodiment, the coil of contactless card 104 may act as the secondary of an air core transformer. The terminal may communicate with the contactless card 104 by cutting power or amplitude modulation. The contactless card 104 may infer the data transmitted from the terminal using the gaps in the power connection of the contactless card 104, which may be functionally maintained through one or more capacitors. The contactless card 104 may communicate back by switching a load on the coil of the contactless card 104 or load modulation. Load modulation may be detected in the terminal's coil through interference. More generally, using the antenna(s) 614, processor 612, and/or the memory 108, the contactless card 104 provides a communications interface to communicate via NFC, Bluetooth, and/or Wi-Fi communications.

As explained above, contactless card 104 may be built on a software platform operable on smart cards or other devices having limited memory, such as JavaCard, and one or more or more applications or applets may be securely executed. Applet 110 may be added to contactless cards to provide a one-time password (OTP) for multifactor authentication (MFA) in various mobile application-based use cases. Applet 110 may be configured to respond to one or more requests, such as near field data exchange requests, from a reader, such as a mobile NFC reader (e.g., of a mobile computing device 102 or point-of-sale terminal), and produce an NDEF message that comprises a cryptographically secure OTP encoded as an NDEF text tag. The NDEF message may include a cryptogram such as the cryptogram 122, and any other data.

One example of an NDEF OTP is an NDEF short-record layout (SR=1). In such an example, one or more applet 110 may be configured to encode the OTP as an NDEF type 4 well known type text tag. In some examples, NDEF messages may comprise one or more records. The applet 110 may be configured to add one or more static tag records in addition to the OTP record.

In some examples, the one or more applet 110 may be configured to emulate an RFID tag. The RFID tag may include one or more polymorphic tags. In some examples, each time the tag is read, different cryptographic data is presented that may indicate the authenticity of the contactless card. Based on the one or more applet 110, an NFC read of the tag may be processed, the data may be transmitted to a server, such as a server of a banking system, and the data may be validated at the server.

In some examples, the contactless card 104 and server may include certain data such that the card may be properly identified. The contactless card 104 may include one or more unique identifiers (not pictured). Each time a read operation takes place, the counter 116 may be configured to increment. In some examples, each time data from the contactless card 104 is read (e.g., by a mobile device), the counter 116 is transmitted to the server for validation and determines whether the counter 116 are equal (as part of the validation) to a counter of the server.

The one or more counter 116 may be configured to prevent a replay attack. For example, if a cryptogram has been obtained and replayed, that cryptogram is immediately rejected if the counter 116 has been read or used or otherwise passed over. If the counter 116 has not been used, it may be replayed. In some examples, the counter that is incremented on the contactless card 104 is different from the counter that is incremented for transactions. The contactless card 104 is unable to determine the application transaction counter 116 since there is no communication between applets 110 on the contactless card 104. In some examples, the contactless card 104 may comprise a first applet 440-1, which may be a transaction applet, and a second applet 440-2. Each applet 440-1 and 440-2 may comprise a respective counter 116.

In some examples, the counter 116 may get out of sync. In some examples, to account for accidental reads that initiate transactions, such as reading at an angle, the counter 116 may increment but the application does not process the counter 116. In some examples, when the mobile device 10 is woken up, NFC may be enabled and the computing device 102 may be configured to read available tags, but no action is taken responsive to the reads.

To keep the counter 116 in sync, an application, such as a background application, may be executed that would be configured to detect when the computing device 102 wakes up and synchronize with the server of a banking system indicating that a read that occurred due to detection to then move the counter 116 forward. In other examples, Hashed One Time Password may be utilized such that a window of mis-synchronization may be accepted. For example, if within a threshold of 10, the counter 116 may be configured to move forward. But if within a different threshold number, for example within 10 or 600, a request for performing re-synchronization may be processed which requests via one or more applications that the user tap, gesture, or otherwise indicate one or more times via the user's device. If the counter 116 increases in the appropriate sequence, then it possible to know that the user has done so.

The key diversification technique described herein with reference to the counter 116, master key 114, UDK 118, and diversified key 120, is one example of encryption and/or decryption a key diversification technique. This example key diversification technique should not be considered limiting of the disclosure, as the disclosure is equally applicable to other types of key diversification techniques.

During the creation process of the contactless card 104, two cryptographic keys may be assigned uniquely per card. The cryptographic keys may comprise symmetric keys which may be used in both encryption and decryption of data. Triple DES (3DES) algorithm may be used by EMV and it is implemented by hardware in the contactless card 104. By using the key diversification process, one or more keys may be derived from a master key based upon uniquely identifiable information for each entity that requires a key.

In some examples, to overcome deficiencies of 3DES algorithms, which may be susceptible to vulnerabilities, a session key may be derived (such as a unique key per session) but rather than using the master key, the unique card-derived keys (e.g., the UDKs 118) and the counter may be used as diversification data. For example, each time the contactless card 104 is used in operation, a different key may be used for creating the message authentication code (MAC) and for performing the encryption. This results in a triple layer of cryptography. The session keys may be generated by the one or more applets and derived by using the application transaction counter with one or more algorithms (as defined in EMV 4.3 Book 2 A1.3.1 Common Session Key Derivation).

Further, the increment for each card may be unique, and assigned either by personalization, or algorithmically assigned by some identifying information. For example, odd numbered cards may increment by 2 and even numbered cards may increment by 5. In some examples, the increment may also vary in sequential reads, such that one card may increment in sequence by 1, 3, 5, 2, 2, . . . repeating. The specific sequence or algorithmic sequence may be defined at personalization time, or from one or more processes derived from unique identifiers. This can make it harder for a replay attacker to generalize from a small number of card instances.

The authentication message may be delivered as the content of a text NDEF record in hexadecimal ASCII format. In another example, the NDEF record may be encoded in hexadecimal format.

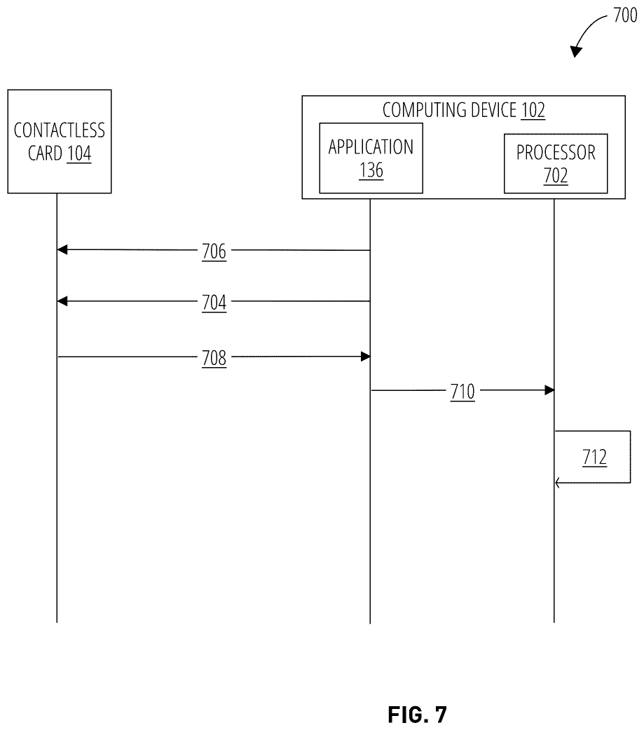

FIG. 7 is a timing diagram illustrating an example sequence for providing authenticated access according to one or more embodiments of the present disclosure. Sequence flow 700 may include contactless card 104 and computing device 102, which may include an application 136 and processor 702. The application 136 can be any of the applications that execute on the computing device 102.

At line 706, the application 136 communicates with the contactless card 104 (e.g., after being brought near the contactless card 104). Communication between the application 136 and the contactless card 104 may involve the contactless card 104 being sufficiently close to a card reader (not shown) of the computing device 102 to enable NFC data transfer between the application 136 and the contactless card 104.

At line 704, after communication has been established between computing device 102 and contactless card 104, contactless card 104 generates a message authentication code (MAC) cryptogram. In some examples, this may occur when the contactless card 104 is read by the application 136. In particular, this may occur upon a read, such as an NFC read, of a near field data exchange (NDEF) tag, which may be created in accordance with the NFC Data Exchange Format. For example, a reader application, such as application 136, may transmit a message, such as an applet select message, with the applet ID of an NDEF producing applet. Upon confirmation of the selection, a sequence of select file messages followed by read file messages may be transmitted. For example, the sequence may include “Select Capabilities file”, “Read Capabilities file”, and “Select NDEF file”. At this point, a counter value maintained by the contactless card 104 may be updated or incremented, which may be followed by “Read NDEF file.” At this point, the message may be generated which may include a header and a shared secret. Session keys may then be generated. The MAC cryptogram may be created from the message, which may include the header and the shared secret. The MAC cryptogram may then be concatenated with one or more blocks of random data, and the MAC cryptogram and a random number (RND) may be encrypted with the session key. Thereafter, the cryptogram and the header may be concatenated, and encoded as ASCII hex and returned in NDEF message format (responsive to the “Read NDEF file” message).

In some examples, the MAC cryptogram may be transmitted as an NDEF tag, and in other examples the MAC cryptogram may be included with a uniform resource indicator (e.g., as a formatted string). In some examples, application 136 may be configured to transmit a request to contactless card 104, the request comprising an instruction to generate a MAC cryptogram.

At line 708, the contactless card 104 sends the MAC cryptogram to the application 136. In some examples, the transmission of the MAC cryptogram occurs via NFC, however, the present disclosure is not limited thereto. In other examples, this communication may occur via Bluetooth, Wi-Fi, or other means of wireless data communication. At line 710, the application 136 communicates the MAC cryptogram to the processor 702.

At line 712, the computing device 102, using a processor 702, verifies the MAC cryptogram pursuant to an instruction from the application 122. For example, the MAC cryptogram may be verified, as explained below. In some examples, verifying the MAC cryptogram may be performed by a device other than computing device 102, such as the server 106. For example, processor 702 may output the MAC cryptogram for transmission to the server 106, which may verify the MAC cryptogram. In some examples, the MAC cryptogram may function as a digital signature for purposes of verification. Other digital signature algorithms, such as public key asymmetric algorithms, e.g., the Digital Signature Algorithm and the RSA algorithm, or zero knowledge protocols, may be used to perform this verification.

FIG. 8 illustrates an NDEF short-record layout (SR=1) data structure 800 according to an example embodiment. One or more applets 110 may be configured to encode an OTP as an NDEF type 4 well known type text tag. In some examples, NDEF messages may comprise one or more records. The applets may be configured to add one or more static tag records in addition to the OTP record. Exemplary tags include, without limitation, Tag type: well known type, text, encoding English (en); Applet ID: D2760000850101; Capabilities: read-only access; Encoding: the authentication message may be encoded as ASCII hex; type-length-value (TLV) data may be provided as a personalization parameter that may be used to generate the NDEF message. In an embodiment, the authentication template may comprise the first record, with a well-known index for providing the actual dynamic authentication data. The data structure 800 may include a cryptogram such as cryptogram 122 or cryptogram 202, and any other data provided by the applet 110.

FIG. 9 illustrates a diagram of a system 900 configured to implement one or more embodiments of the present disclosure. As explained below, during the contactless card creation process, two cryptographic keys may be assigned uniquely for each card. The cryptographic keys may comprise symmetric keys which may be used in both encryption and decryption of data. Triple DES (3DES) algorithm may be used by EMV and it is implemented by hardware in the contactless card. By using a key diversification process, one or more keys may be derived from a master key based upon uniquely identifiable information for each entity that requires a key.

Regarding master key management, two issuer master keys 902, 926 may be required for each part of the portfolio on which the one or more applets is issued. For example, the first master key 902 may comprise an Issuer Cryptogram Generation/Authentication Key (Iss-Key-Auth) and the second master key 926 may comprise an Issuer Data Encryption Key (Iss-Key-DEK). As further explained herein, two issuer master keys 902, 926 are diversified into card master keys 908, 920, which are unique for each card. In some examples, a network profile record ID (pNPR) 522 and derivation key index (pDKI) 924, as back office data, may be used to identify which Issuer Master Keys 902, 926 to use in the cryptographic processes for authentication. The system performing the authentication may be configured to retrieve values of pNPR 922 and pDKI 924 for a contactless card at the time of authentication.

In some instances, the issuer master keys 902, 926 may not be stored on the card but may be utilized at the time of manufacture of provisioning of the card to generate the card master keys 908, 920. The card master keys 908, 920 may be securely provisioned and stored on the contactless card. As discussed below, the card master keys 908, 920 are then utilized to generate diversified session keys 930, 910.

In some examples, to increase the security of the solution, a session key may be derived (such as a unique key per session) but rather than using the master key, the unique card-derived keys and the counter may be used as diversification data, as explained above. For example, each time the card is used in operation, a different key may be used for creating the message authentication code (MAC) and for performing the encryption. Regarding session key generation, the keys used to generate the cryptogram and encipher the data in the one or more applets may comprise session keys based on the card unique keys (Card-Key-Auth 908 and Card-Key-Dek 920). The session keys (Aut-Session-Key 930 and DEK-Session-Key 910) may be generated by the one or more applets and derived by using the application transaction counter (pATC) 904 with one or more algorithms. To fit data into the one or more algorithms, only the 2 low order bytes of the 4-byte pATC 904 is used. In some examples, the four byte session key derivation method may comprise: F1:=PATC(lower 2 bytes)∥‘F0’∥‘00’∥PATC (four bytes) F1:=PATC(lower 2 bytes)∥‘0F’∥‘00’∥PATC (four bytes) SK:={(ALG (MK)[F1])∥ALG (MK)[F2]}, where ALG may include 3DES ECB and MK may include the card unique derived master key.

As described herein, one or more MAC session keys may be derived using the lower two bytes of pATC 904 counter. At each tap of the contactless card 104, pATC 904 is configured to be updated, and the card master keys Card-Key-AUTH 508 and Card-Key-DEK 920 are further diversified into the session keys Aut-Session-Key 930 and DEK-Session-KEY 910. pATC 904 may be initialized to zero at personalization or applet initialization time. In some examples, the pATC counter 904 may be initialized at or before personalization, and may be configured to increment by one at each NDEF read.

Further, the update for each card may be unique, and assigned either by personalization, or algorithmically assigned by pUID or other identifying information. For example, odd numbered cards may increment or decrement by 2 and even numbered cards may increment or decrement by 5. In some examples, the update may also vary in sequential reads, such that one card may increment in sequence by 1, 3, 5, 2, 2, . . . repeating. The specific sequence or algorithmic sequence may be defined at personalization time, or from one or more processes derived from unique identifiers. This can make it harder for a replay attacker to generalize from a small number of card instances.

The authentication message may be delivered as the content of a text NDEF record in hexadecimal ASCII format. In some examples, only the authentication data and an 8-byte random number followed by MAC of the authentication data may be included. In some examples, the random number may precede cryptogram A and may be one block long. In other examples, there may be no restriction on the length of the random number. In further examples, the total data (i.e., the random number plus the cryptogram) may be a multiple of the block size. In these examples, an additional 8-byte block may be added to match the block produced by the MAC algorithm. As another example, if the algorithms employed used 16-byte blocks, even multiples of that block size may be used, or the output may be automatically, or manually, padded to a multiple of that block size.

The MAC may be performed by a function key (AUT-Session-Key) 930. The data specified in cryptogram may be processed with javacard.signature method: ALG_DES_MAC8_ISO9797_1_M2_ALG3 to correlate to EMV ARQC verification methods. The key used for this computation may comprise a session key AUT-Session-Key 930, as explained above. As explained above, the low order two bytes of the counter may be used to diversify for the one or more MAC session keys. As explained below, AUT-Session-Key 930 may be used to MAC data 906, and the resulting data or cryptogram A 914 and random number RND may be encrypted using DEK-Session-Key 910 to create cryptogram B or output 918 sent in the message.

In some examples, one or more HSM commands may be processed for decrypting such that the final 16 (binary, 32 hex) bytes may comprise a 3DES symmetric encrypting using CBC mode with a zero IV of the random number followed by MAC authentication data. The key used for this encryption may comprise a session key DEK-Session-Key 910 derived from the Card-Key-DEK 920. In this case, the ATC value for the session key derivation is the least significant byte of the counter pATC 904.

The format below represents a binary version example embodiment. Further, in some examples, the first byte may be set to ASCII ‘A’.

Message Format

| 1 | 2 | 4 | 8 | 8 |
|---|---|---|---|---|
| 0x43 (Message Type ‘A’) | Version | pATC | RND | Cryptogram A (MAC) |
| Cryptogram A (MAC) | 8 bytes | | | |

| Mac of | | | | |
|---|---|---|---|---|
| 2 | 8 | 4 | 4 | 18 bytes input data |
| Version | pUID | pATC | Shared Secret | |

Message Format

| 1 | 2 | 4 | | 16 | |
|---|---|---|---|---|---|
| 0x43 (Message Type ‘A’) | Version | pATC | | Cryptogram B | |
| Cryptogram A (MAC) | 8 bytes | | | | |
| MAC of | | | | | |
| 2 | 8 | 4 | 4 | | 18 bytes input data |
| Version | pUID | pATC | Shared Secret | | |
| Cryptogram B | 16 | | | | |
| Sym Encryption of | | | | | |
| 8 | 8 | | | | |

| | |
|---|---|
| RND | Cryptogram A |

Another exemplary format is shown below. In this example, the tag may be encoded in hexadecimal format.

Message Format

| 2 | 8 | 4 | 8 | 8 |
|---|---|---|---|---|
| Version | pUID | pATC | RND | Cryptogram A (MAC) |
| 8 bytes | | | | |

| 8 | 8 | 4 | 4 | 18 bytes input data |
|---|---|---|---|---|
| pUID | pUID | pATC | Shared Secret | |

Message Format

| 2 | 8 | 4 | | 16 | |
|---|---|---|---|---|---|
| Version | pUID | pATC | | Cryptogram B | |
| 8 bytes | | | | | |
| 8 | | 4 | 4 | | 18 bytes input data |
| pUID | pUID | pATC | Shared Secret | | |
| Cryptogram B | 16 | | | | |
| Sym Encryption of | | | | | |
| 8 | 8 | | | | |
| RND | Cryptogram A | | | | |

The UID field of the received message may be extracted to derive, from master keys Iss-Key-AUTH 502 and Iss-Key-DEK 926, the card master keys (Card-Key-Auth 908 and Card-Key-DEK 920) for that particular card. Using the card master keys (Card-Key-Auth 508 and Card-Key-DEK 920), the counter (pATC) field of the received message may be used to derive the session keys (Aut-Session-Key 930 and DEK-Session-Key 910) for that particular card. Cryptogram B 918 may be decrypted using the DEK-Session-KEY, which yields cryptogram A 914 and RND, and RND may be discarded. The UID field may be used to look up the shared secret of the contactless card which, along with the Ver, UID, and pATC fields of the message, may be processed through the cryptographic MAC using the re-created Aut-Session-Key to create a MAC output, such as MAC′. If MAC′ is the same as cryptogram A 914, then this indicates that the message decryption and MAC checking have all passed. Then the pATC may be read to determine if it is valid.

During an authentication session, one or more cryptograms may be generated by the one or more applications. For example, the one or more cryptograms may be generated as a 3DES MAC using ISO 9797-1 Algorithm 3 with Method 2 padding via one or more session keys, such as Aut-Session-Key 930. The input data 906 may take the following form: Version (2), pUID (8), pATC (4), Shared Secret (4). In some examples, the numbers in the brackets may comprise length in bytes. In some examples, the shared secret may be generated by one or more random number generators which may be configured to ensure, through one or more secure processes, that the random number is unpredictable. In some examples, the shared secret may comprise a random 4-byte binary number injected into the card at personalization time that is known by the authentication service. During an authentication session, the shared secret may not be provided from the one or more applets to the mobile application. Method 2 padding may include adding a mandatory 0x‘80’ byte to the end of input data and 0x‘00’ bytes that may be added to the end of the resulting data up to the 8-byte boundary. The resulting cryptogram may comprise 8 bytes in length.

In some examples, one benefit of encrypting an unshared random number as the first block with the MAC cryptogram, is that it acts as an initialization vector while using CBC (Block chaining) mode of the symmetric encryption algorithm. This allows the “scrambling” from block to block without having to pre-establish either a fixed or dynamic IV.

By including the application transaction counter (pATC) as part of the data included in the MAC cryptogram, the authentication service may be configured to determine if the value conveyed in the clear data has been tampered with. Moreover, by including the version in the one or more cryptograms, it is difficult for an attacker to purposefully misrepresent the application version in an attempt to downgrade the strength of the cryptographic solution. In some examples, the pATC may start at zero and be updated by 1 each time the one or more applications generates authentication data. The authentication service may be configured to track the pATCs used during authentication sessions. In some examples, when the authentication data uses a pATC equal to or lower than the previous value received by the authentication service, this may be interpreted as an attempt to replay an old message, and the authenticated may be rejected. In some examples, where the pATC is greater than the previous value received, this may be evaluated to determine if it is within an acceptable range or threshold, and if it exceeds or is outside the range or threshold, verification may be deemed to have failed or be unreliable. In the MAC operation 912, data 906 is processed through the MAC using Aut-Session-Key 930 to produce MAC output (cryptogram A) 914, which is encrypted.

In order to provide additional protection against brute force attacks exposing the keys on the card, it is desirable that the MAC cryptogram 914 be enciphered. In some examples, data or cryptogram A 914 to be included in the ciphertext may comprise: Random number (8), cryptogram (8). In some examples, the numbers in the brackets may comprise length in bytes. In some examples, the random number may be generated by one or more random number generators which may be configured to ensure, through one or more secure processes, that the random number is unpredictable. The key used to encipher this data may comprise a session key. For example, the session key may comprise DEK-Session-Key 910. In the encryption operation 916, data or cryptogram A 914 and RND are processed using DEK-Session-Key 510 to produce encrypted data, cryptogram B 918. The data 914 may be enciphered using 3DES in cipher block chaining mode to ensure that an attacker must run any attacks over all of the ciphertext. As a non-limiting example, other algorithms, such as Advanced Encryption Standard (AES), may be used. In some examples, an initialization vector of 0x‘0000000000000000’ may be used. Any attacker seeking to brute force the key used for enciphering this data will be unable to determine when the correct key has been used, as correctly decrypted data will be indistinguishable from incorrectly decrypted data due to its random appearance.

In order for the authentication service to validate the one or more cryptograms provided by the one or more applets, the following data must be conveyed from the one or more applets to the mobile device in the clear during an authentication session: version number to determine the cryptographic approach used and message format for validation of the cryptogram, which enables the approach to change in the future; pUID to retrieve cryptographic assets, and derive the card keys; and pATC to derive the session key used for the cryptogram.

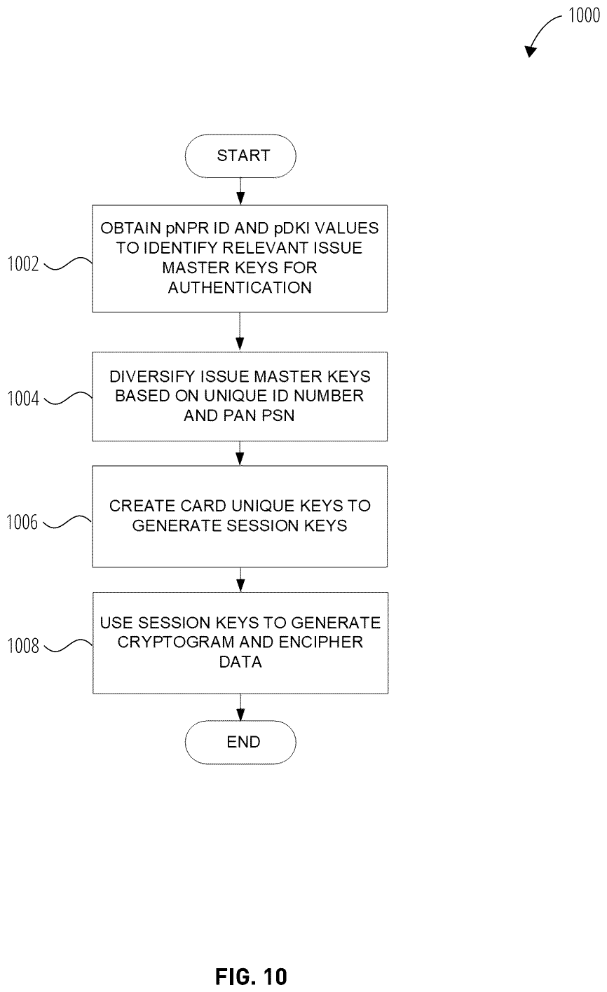

FIG. 10 illustrates a method 1000 for generating a cryptogram. For example, at block 1002, a network profile record ID (pNPR) and derivation key index (pDKI) may be used to identify which Issuer Master Keys to use in the cryptographic processes for authentication. In some examples, the method may include performing the authentication to retrieve values of pNPR and pDKI for a contactless card at the time of authentication.

At block 1004, Issuer Master Keys may be diversified by combining them with the card's unique ID number (pUID) and the PAN sequence number (PSN) of one or more applets, for example, a payment applet.

At block 1006, Card-Key-Auth and Card-Key-DEK (unique card keys) may be created by diversifying the Issuer Master Keys to generate session keys which may be used to generate a MAC cryptogram.

At block 1008, the keys used to generate the cryptogram and encipher the data in the one or more applets may comprise the session keys of block 1030 based on the card unique keys (Card-Key-Auth and Card-Key-DEK). In some examples, these session keys may be generated by the one or more applets and derived by using pATC, resulting in session keys Aut-Session-Key and DEK-Session-Key.

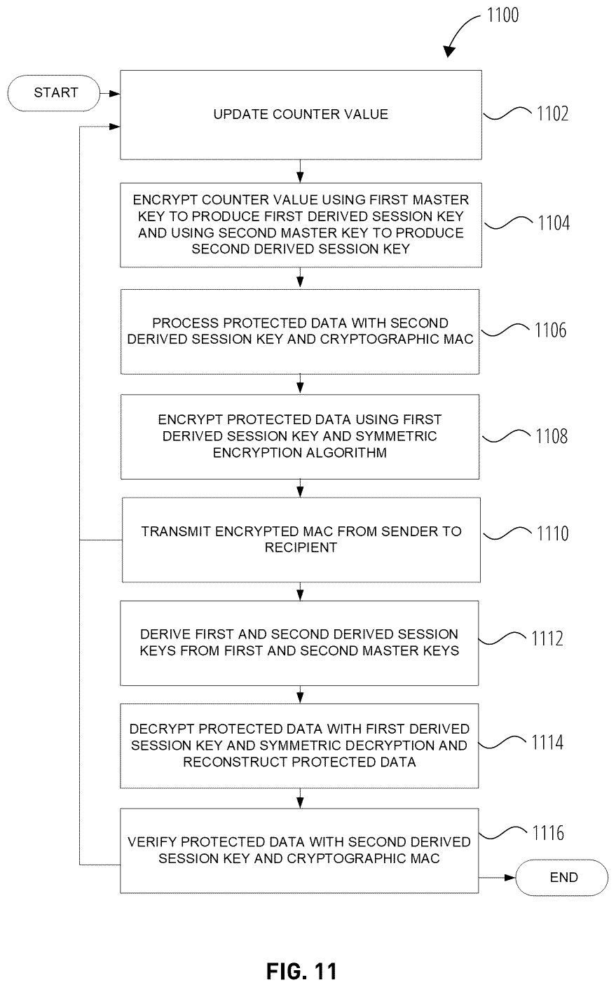

FIG. 11 depicts an exemplary process 1100 illustrating key diversification according to one example. Initially, a sender and the recipient may be provisioned with two different master keys. For example, a first master key may comprise the data encryption master key, and a second master key may comprise the data integrity master key. The sender has a counter value, which may be updated at block 1102, and other data, such as data to be protected, which it may secure share with the recipient.

At block 1104, the counter value may be encrypted by the sender using the data encryption master key to produce the data encryption derived session key, and the counter value may also be encrypted by the sender using the data integrity master key to produce the data integrity derived session key. In some examples, a whole counter value or a portion of the counter value may be used during both encryptions.

In some examples, the counter value may not be encrypted. In these examples, the counter may be transmitted between the sender and the recipient in the clear, i.e., without encryption.

At block 1106, the data to be protected is processed with a cryptographic MAC operation by the sender using the data integrity session key and a cryptographic MAC algorithm. The protected data, including plaintext and shared secret, may be used to produce a MAC using one of the session keys (AUT-Session-Key).

At block 1108, the data to be protected may be encrypted by the sender using the data encryption derived session key in conjunction with a symmetric encryption algorithm. In some examples, the MAC is combined with an equal amount of random data, for example each 8 bytes long, and then encrypted using the second session key (DEK-Session-Key).

At block 1110, the encrypted MAC is transmitted, from the sender to the recipient, with sufficient information to identify additional secret information (such as shared secret, master keys, etc.), for verification of the cryptogram.

At block 1112, the recipient uses the received counter value to independently derive the two derived session keys from the two master keys as explained above.

At block 1114, the data encryption derived session key is used in conjunction with the symmetric decryption operation to decrypt the protected data. Additional processing on the exchanged data will then occur. In some examples, after the MAC is extracted, it is desirable to reproduce and match the MAC. For example, when verifying the cryptogram, it may be decrypted using appropriately generated session keys. The protected data may be reconstructed for verification. A MAC operation may be performed using an appropriately generated session key to determine if it matches the decrypted MAC. As the MAC operation is an irreversible process, the only way to verify is to attempt to recreate it from source data.

At block 1116, the data integrity derived session key is used in conjunction with the cryptographic MAC operation to verify that the protected data has not been modified.

Some examples of the methods described herein may advantageously confirm when a successful authentication is determined when the following conditions are met. First, the ability to verify the MAC shows that the derived session key was proper. The MAC may only be correct if the decryption was successful and yielded the proper MAC value. The successful decryption may show that the correctly derived encryption key was used to decrypt the encrypted MAC. Since the derived session keys are created using the master keys known only to the sender (e.g., the transmitting device) and recipient (e.g., the receiving device), it may be trusted that the contactless card which originally created the MAC and encrypted the MAC is indeed authentic. Moreover, the counter value used to derive the first and second session keys may be shown to be valid and may be used to perform authentication operations.

Thereafter, the two derived session keys may be discarded, and the next iteration of data exchange will update the counter value (returning to block 1102) and a new set of session keys may be created (at block 1110). In some examples, the combined random data may be discarded.

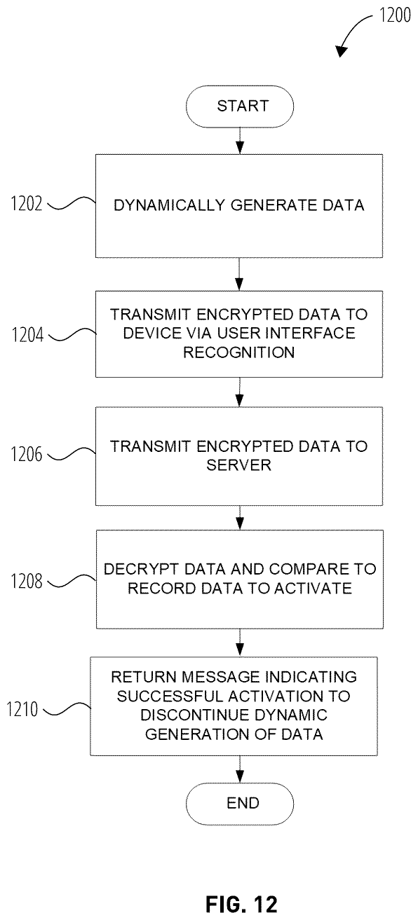

FIG. 12 illustrates a method 1200 for card activation according to an example embodiment. For example, card activation may be completed by a system including a card, a device, and one or more servers. The contactless card, device, and one or more servers may reference same or similar components that were previously explained, such as contactless card 104, computing device 102, and server 106.

In block 1202, the card may be configured to dynamically generate data. In some examples, this data may include information such as an account number, card identifier, card verification value, or phone number, which may be transmitted from the card to the device. In some examples, one or more portions of the data may be encrypted via the systems and methods disclosed herein.

In block 1204, one or more portions of the dynamically generated data may be communicated to an application of the device via NFC or other wireless communication. For example, a tap of the card proximate to the device may allow the application of the device to read the one or more portions of the data associated with the contactless card. In some examples, if the device does not comprise an application to assist in activation of the card, the tap of the card may direct the device or prompt the customer to a software application store to download an associated application to activate the card. In some examples, the user may be prompted to sufficiently gesture, place, or orient the card towards a surface of the device, such as either at an angle or flatly placed on, near, or proximate the surface of the device. Responsive to a sufficient gesture, placement and/or orientation of the card, the device may proceed to transmit the one or more encrypted portions of data received from the card to the one or more servers.

In block 1206, the one or more portions of the data may be communicated to one or more servers, such as a card issuer server. For example, one or more encrypted portions of the data may be transmitted from the device to the card issuer server for activation of the card.

In block 1208, the one or more servers may decrypt the one or more encrypted portions of the data via the systems and methods disclosed herein. For example, the one or more servers may receive the encrypted data from the device and may decrypt it in order to compare the received data to record data accessible to the one or more servers. If a resulting comparison of the one or more decrypted portions of the data by the one or more servers yields a successful match, the card may be activated. If the resulting comparison of the one or more decrypted portions of the data by the one or more servers yields an unsuccessful match, one or more processes may take place. For example, responsive to the determination of the unsuccessful match, the user may be prompted to tap, swipe, or wave gesture the card again. In this case, there may be a predetermined threshold comprising a number of attempts that the user is permitted to activate the card. Alternatively, the user may receive a notification, such as a message on his or her device indicative of the unsuccessful attempt of card verification and to call, email or text an associated service for assistance to activate the card, or another notification, such as a phone call on his or her device indicative of the unsuccessful attempt of card verification and to call, email or text an associated service for assistance to activate the card, or another notification, such as an email indicative of the unsuccessful attempt of card verification and to call, email or text an associated service for assistance to activate the card.

In block 1210, the one or more servers may transmit a return message based on the successful activation of the card. For example, the device may be configured to receive output from the one or more servers indicative of a successful activation of the card by the one or more servers. The device may be configured to display a message indicating successful activation of the card. Once the card has been activated, the card may be configured to discontinue dynamically generating data so as to avoid fraudulent use. In this manner, the card may not be activated thereafter, and the one or more servers are notified that the card has already been activated.

FIG. 13 illustrates an example of system 1300 in accordance with the embodiments discussed herein. The system 1300 includes additional devices and systems configured to enable contactless card issuers to tap-to-card services in a distributed environment. Specifically, system 1300 enables any number of card issuer systems to provide card services, including authentication to their clients through a switching fabric, i.e., the switchboard system, in a secure and safe manner.

In embodiments, the system 1300 includes one or more nodes 1304 configured to perform routing operations. Each switchboard node 1304 may include a session and nonce generator 1306, a message router 1308, an authentication 1310 module, an operation data 1312 store, and a metrics store 1314. Further, each of the nodes may be configured the same and share configurations, but each switchboard node 1304 may independently process and route messages and requests to the appropriate systems, such as the merchant (authenticator) systems and issuer systems. Each of the nodes 1304 is configured to act as a broker of trust between an issuer system, the merchant system 1322, and/or validation system 1324, for example. Each switchboard node 1304 is configured to route each message to the correct issuer system while maintaining data security. For example, a switchboard node 1304 may route a message between an issuer system and a merchant system while the node is not able to gain access to the private data in the message.

The switchboard system may be configured as a server system, including a collection of hardware, software, and networking components that work together to provide services to the clients. Hardware components may include one or more server computers, storage devices, and network adapters. The server computers are configured to run server applications, such as those executable on each of the nodes 1304. In some instances, each of the server computers may be configured to operate one or more nodes, e.g., in a virtual environment. The storage devices are configured to store data that is accessed by the applications, and the network adapters are used to connect the server computer to the network.

Each of the server computers may be configured to execute software, including the operating system, the applications, and security software. The networking components of a server system include the network switch, router, and firewall. The network switch is used to connect the server computers to other devices on the network. The router is used to route traffic between different networks. The firewall is used to protect the server system from unauthorized access and attacks.

In some embodiments, the nodes 1304 may operate in a cloud-based computing environment, e.g., a collection of hardware, software, and networking components that enable the delivery of cloud computing services. The switchboard nodes 1304 and the computing services are delivered over the Internet, and they can be accessed from anywhere in the world with an Internet connection. In embodiments, a client 1336 may access a switchboard node 1304 through Domain Name System 1302 or domain name system (DNS). The DNS 1302 a hierarchical and distributed naming system for computers, services, and other resources connected to the Internet or other networks. It associates various information with domain names assigned to each registered participant. In one example, the DNS 1302 may translate a name known to software executing on a client 1336 to route data to one or more of switchboard node 1304 of the switchboard system. In embodiments, the DNS 1302 may generate into a number, such as an Internet Protocol (IP) address, an address record (A-record), or another Host name (C-name record). At a high level, the Domain Name System 1302 translates known domain names to numerical Internet Protocol (IP) addresses needed for locating and identifying computer services and devices with the underlying network protocols. Clients use the global DNS system to select the best node to use.

In embodiments, a client 1336 communicates with the switchboard system to perform one or more of the partner services 1332, such as conducting a transaction with a merchant, validate the customer, or other tap-to functions. Once the client 1336 identifies a switchboard node 1304 and resolves an address to communicate with the switchboard node 1304, the client 1336 may send one or more messages to the switchboard node 1304 to authenticate and perform the operation. The switchboard node 1304 includes an authentication 1310 function that is configured to authenticate the client 1336. In embodiments, the client 1336 sends a message or authorization request to the switchboard node 1304 with the following header set:
X-Sb-Api-Key: <CLIENT API KEY>
X-Sb-Dvc-Fngrprnt: Device-specific device fingerprint

The CLIENT API KEY may have the following example structure: 65535-GReyx5BuEAaE72bWbFZJfHRL8Dbt1Uum, where table 1 describes the value, name, and meaning:

TABLE 1

| Value | Name | Meaning |
|---|---|---|
| 65535 | Client ID | Individual |
| | | identifier |
| | | of client |
| GReyx5BuEAaE72bWbFZJfHRL8Dbt1Uum | Client Key | Randomly |
| | | assigned key |

The switchboard node 1304 may authorize or authenticate the client 1336 or user, and the switchboard node 1304 may utilize the additional components, such as the session and nonce generator 206 and message router 208, to perform the operations. Note the Validators validation systems 224 never interact with the merchant systems 222, nor vice versa. The nodes 204 broker all communication.

In embodiments, the switchboard system may utilize a hyperledger fabric 1320 to manage to synchronize the shared operation data 1312 and member management across the network. The hyperledger fabric 1320 is a distributed ledger framework having a permission network model that only authorized participants can join the network and access the data that is stored on a ledger.

In embodiments, the hyperledger fabric 1320 may be generated by creating one or more set of peers, an ordering service, and a channel. Once the network is created, the system 1300 deploys chaincode to the network or nodes 1304 permitted to access the fabric. The chaincode is the code that runs on the blockchain and executes the network control 1326 and operation data 1312 logic code. Once the chaincode is deployed, each of the switchboard nodes 1304 is configured to invoke transactions on the blockchain to add data to the blockchain, e.g., the operational data. A switchboard node 1304 or another device can query the ledger to retrieve data. The ledger is a distributed database that stores all of the data that has been added to the blockchain.

All nodes 1304 keep an independently verifiable log of their actions that can be transmitted to a centralized aggregator to build a picture of overall network usage. At a central level, system 1300 can manage network operation data and management and have a centralized view of network use, aggregated and abstracted to the appropriate level.

In accordance with embodiments discussed herein, the system 1300 enables any number of contactless card issuers to provide contactless cards 104 to their customers. The customers may utilize their contactless cards 104 to authenticate themselves to post messages on a social media site, for example. System 1300 may route data, e.g., a cryptogram, encrypted data, signed data, etc. from a contactless card 104 through the client 1336 to the appropriate authenticator or validator, e.g., partner services 1332 and/or validation system 1324. The data may be authenticated and result may be returned to the correct server to enable an operation to be performed, e.g., posting an authenticated post on a social media site.

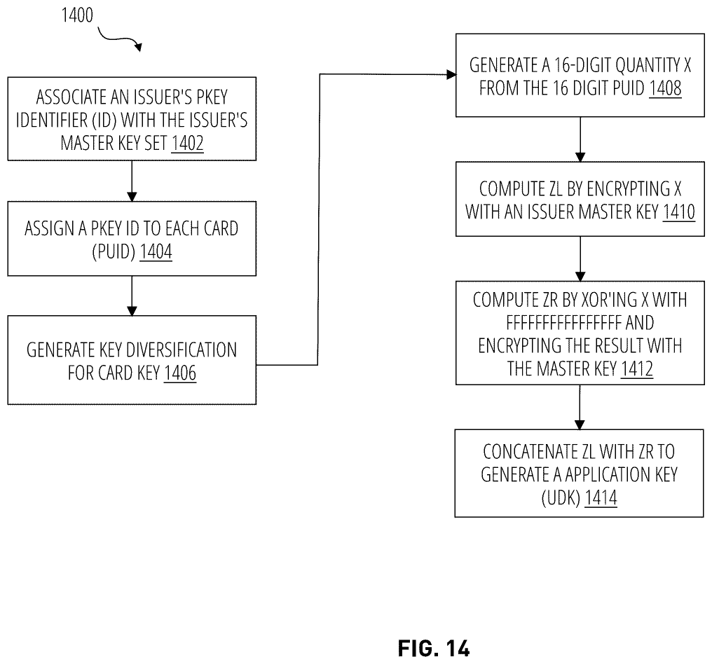

In a multi-issuer distributed environment, each issuer may be associated with and generate their own master keys that may be used to further generate card master keys for each card issued. The flows discussed in FIG. 14 through FIG. 18 may be performed to generate encrypted data that may be properly routed through system 1300 to perform authentication techniques. In embodiments, the cryptogram or encrypted data generated based on FIG. 14 through FIG. 18 can be utilized to perform authentication of a user in the social media environment as discussed herein. These flows may be different than flows discussed in FIG. 9 through FIG. 12, which are generally performed in a single card issuer environment. Embodiments are not limited in this manner.

FIG. 14 illustrates flow 1400, an example of operations to identify the issuer's master keys and generate unique card master keys or application keys. In some instances, these operations may be performed off the card, at personalization time, and then stored in a memory of the card. Further, the issuer's master key(s) may be utilized to generate card master keys. The card master keys may be known as application keys or UDKs. Each contactless card may have one or more UDKs.

In embodiments, Each contactless card includes one or more applications, such as an authentication application, that is given a unique 16-digit identity (pUID) at time of personalization. Each contactless card may also receive application keys, which may also be known as unique card keys (UDKs) or card master keys using the pUID. In some instances, these operations are performed off-card, and the resultant keys are injected during personalization. However, in other instances, these one or more of the operations may be performed on card, e.g., at the time of manufacturer, each time an operation is performed with a key, and so forth.

At block 1402, embodiments include a system configured to generate a number of issuer master key sets and assign each a unique three-byte pKey identifier (pKey ID). As mentioned, systems discussed herein may support many card issuers, and each card issuer may have one or more of its own sets of unique issuer master keys that can be identified with a pKey ID. For each application, such as the authentication application, the system may perform the operations discussed in blocks block 1404 to block 1414.

At block 1404, the system assigns a pKey ID to a card or pUID, a card application's unique 16-decimal digital identify. At block 1406, the system initiates generating a card's UDK(s). At block 1408, the system generates a 16-digit quantity (X) from the 16-digit pUID. In one example, the 16-digit X may be generated by randomly rearranging the 16-digit pUID. In another example, X may be the same as the 16-digit pUID. Embodiments are not limited in this manner, and other techniques may be utilized to generate X from the 16-digit pUID. In embodiments, the 16-digit quantity X may be utilized to generate one or more UDKs.

At block 1410, the system computes or calculates (ZL) by encrypting X with an issuer master key. An encryption algorithm, such as DES or DES variant, may be utilized in embodiments. Embodiments are not limited in this manner, and other examples of encryption algorithms include AES and public-key algorithms, such as (RSA).

At block 1412, the system calculates or computes ZR is by XOR'ing X with FFFFFFFFFFFFFFFF and encrypting the result with an issuer master key. Again, an encryption algorithm such as DES, AES, RSA, etc, may be used to encrypt the result of the XOR'ing. At block 1414, the system generates an application key or UDK. Specifically, the system concatenates ZL with ZR to form the application key. Embodiments are not limited to concatenating the two portions (ZL and ZR). They may be combined using other techniques. Additionally, the above-described process can be performed any number of times to generate additional application keys, e.g., by utilizing different master issuer keys.

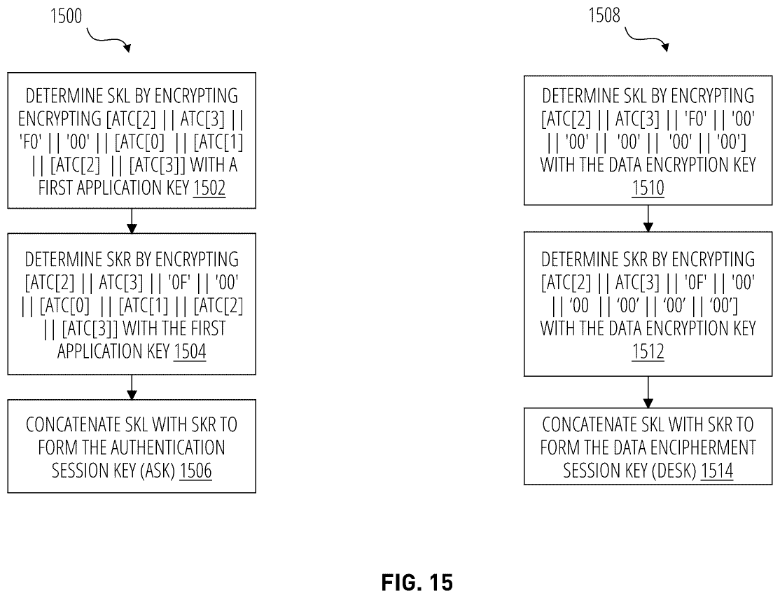

FIG. 15 illustrates a first flow 1500 to generate a unique cryptogram session key (ASK) and a second flow 1508 to generate a unique encipherment session key (DESK) in accordance embodiments. The operations discussed in flow 1500 and flow 1508 may be performed on the contactless card.

At block 1502, the contactless card including circuitry compute SKL by encrypting [ATC[2]∥ATC[3]∥‘F0’∥‘00’∥[ATC[0]∥[ATC[1]∥[ATC[2]∥[ATC[3]] with an application key, e.g., the key generated in flow 1400. Further, at block 1504 the contactless card compute SKR by encrypting [ATC[2]∥ATC[3]∥‘0F’∥‘00’∥[ATC[0]∥[ATC[1]∥[ATC[2]∥[ATC[3]] with the application key. Finally and at block 1506, the contactless card concatenates SKL with SKR to form an authentication session key (ASK). In embodiments, the ASK is used to perform operations utilizing the contactless card, such as encrypting the cryptographic MAC.

In embodiments, a card applet also supports session key derivation to generate a unique encipherment session key DESK as shown in flow 1508. At block 1510, the contactless card including circuitry Compute SKL by encrypting [ATC[2]∥ATC[3]∥‘F0’∥‘00’∥‘00’∥‘00’∥‘00’∥‘00’] with the Data Encryption Key (DEK) Further and at block 1512, the contactless card computes SKR by encrypting [ATC[2]∥ATC[3]∥‘0F’∥‘00’∥‘00∥‘00’∥‘00’∥‘00’] with the Data Encryption Key At block 1514, the contactless card concatenate SKL with SKR to form the Data Encipherment Session Key.

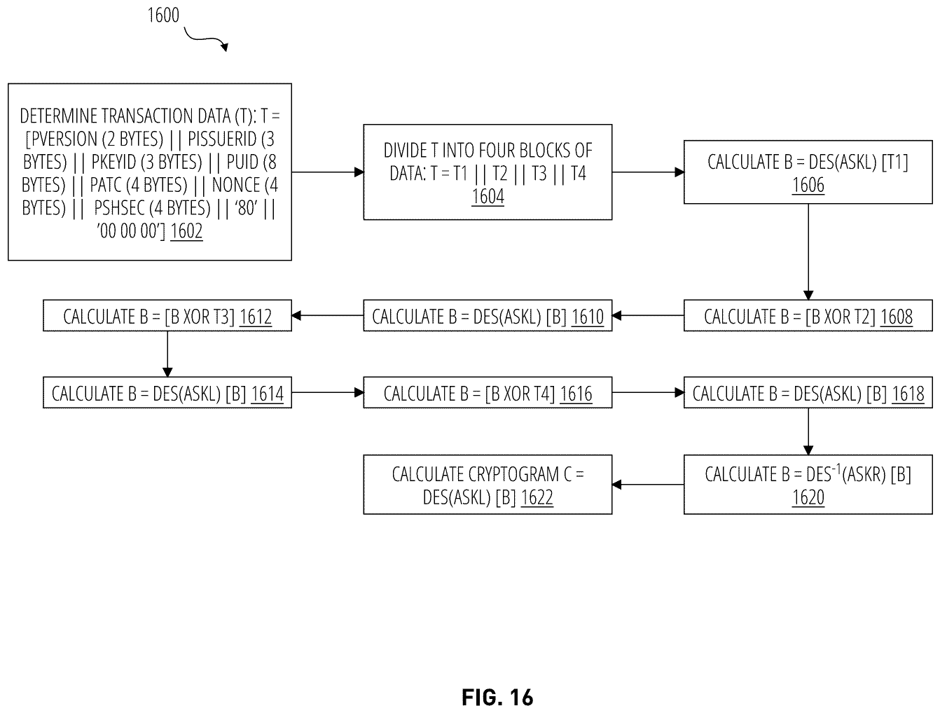

FIG. 16 illustrates an example flow 1600 that may be performed by a contactless card or circuitry thereon to generate a cryptogram to perform operations discussed herein, e.g., see FIG. 19, message 1900. The cryptogram C is determined by calculating a MAC over the 32-byte transaction data T using the Authentication Session Key (ASK). FIG. 15, flow 1500 illustrates and discusses generating an ASK in accordance with embodiments discussed herein.

At block 1402, the contactless card including circuitry computes T=[pVersion (2 bytes)∥pIssuerID (3 bytes)∥pKeyID (3 bytes)∥pUID (8 bytes)∥pATC (4 bytes)∥nonce (4 bytes)∥pSHSEC (4 bytes)∥‘80’∥‘00 00 00’]. In one example, the pVersion is an applet version number, the pIssuerID is an issuer identifier, the pKeyID includes data that identifies a set of master keys for a card issuer of the contactless card, the pUID is a card unique identifier assigned to the contactless card, the pATC is a card's counter vlaue, the nonce is the nonce provided during communication with another device as described herein, and the pSHSEC is value to indicate adherence to Secure Hardware Security Evaluation Criteria.

The contactless card may process the data to generate the cryptogram. At block 1404, the contactless card divides T into four blocks of 8 bytes of data: T=T1∥T2∥T3∥T4. At block 1406, the contactless card computes B=DES(ASKL) [T1], where is the Data Encryption Standard or another symmetric encryption algorithm, ASKL is a portion of the ASK, e.g., the “left” half of the key. At block 1408, the contactless card computes B=[B XOR T2], and at block 1410, the contactless card computes B=DES(ASKL) [B], where DES is an encryption algorithm. At block 1412, the contactless card computes B=[B XOR T3], and at block 1414, the contactless card computes B=DES(ASKL) [B]. At block 1416, the contactless card computes B=[B XOR T4] and at block 1418 the contactless card computes B=DES(ASKL) [B]. At block 1420, the contactless card compute B=DES-1(ASKR) [B], where DES-1 is the reciprocal DES operation and ASKR is a portion of the ASK, e.g., the right half. At block 422, the contactless card computes the cryptogram C=DES(ASKL) [B].

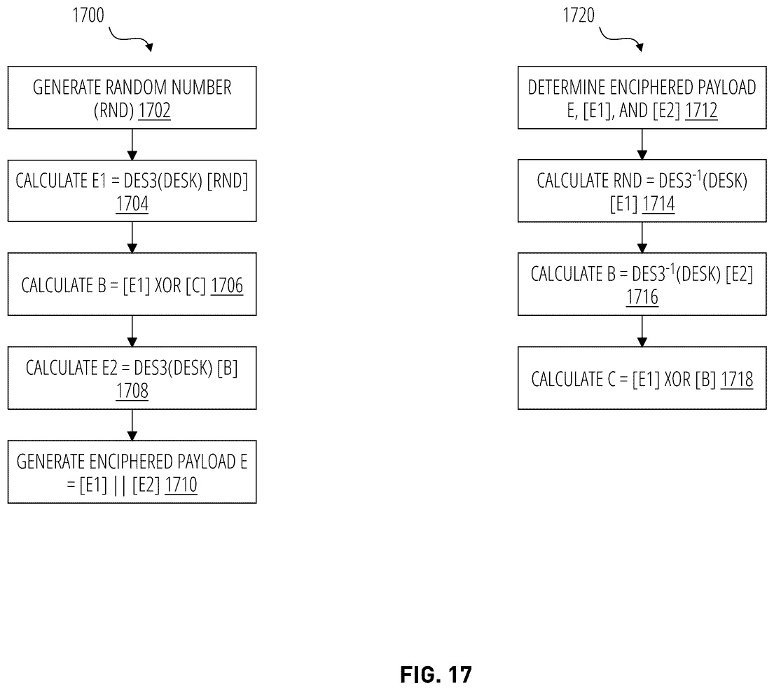

In embodiments, a contactless card may encipher the cryptogram to secure the data further. FIG. 17 illustrates an example flow 1700 to encipher the cryptogram with the Data Encipherment Session Key (DESK) (FIG. 15, flow 1508) being used to encrypt in Cipher Block Chaining mode (CBC).

At block 1702, a contactless card including circuitry is configured to generate an 8-byte random number [RND]. At block 1704, the contactless card computes E1=DES3(DESK) [RND], where DES3 is a symmetric encryption algorithm such as the Triple Data Encryption Standard. At block 1706, the contactless card computes B=[E1] XOR [C], where C is the cryptogram generated in flow 1600. The contactless card computes E2=DES3(DESK) [B] at block 1708, where B is computed above in FIG. 16, flow 1600. At block 1710 the contactless card generates the 16 byte enciphered payload E=[E1]∥[E2].

In embodiments, a device or the contactless card my decrypt the payload E in accordance with flow 1720. At block 1712, a device determines or retrieves the payload E. At block 1714, the device computes a RND=DES3⁻¹(DESK) [E1]. At block 1716, the device determines B=DES3⁻¹(DESK) [E2], and at block 1718, the device computes C=[E1] XOR [B].

FIG. 18 illustrates an example flow 1800 for calculate a message authentication code (MAC). The operations of flow 1800 by circuitry of the contactless card. In some instances, the MAC may be an updated MAC. In embodiments, the updated MAC is included in data communicated from a contactless card to another device, such as a mobile device, point-of-sale (POS) terminal, or any other type of computer. In one example, the update MAC may be included in an NDEF message.

In embodiments, the updated MAC may be calculated to protect the control indicators and include updated date/time. For example, the update MAC M is determined by calculating a MAC over the 10 bytes of the update data U with the Update MAC Card Key (MCK) as follows.

At block 1802, embodiments include determining data to process through a number of calculations and computations. In one example, the data U equals the [Control Indicators (2 bytes)∥Update Date Time (8 bytes)∥‘80’∥‘00 00 00 00 00’]. For the calculations, the data may be divided into two separate portions. Specifically, at block 1804, data U is broken into two blocks of 8 bytes of data, where U=U₁∥U₂. Further, operations may be performed on U₁ and U₂.

At block 1806 embodiments include applying an algorithm to the first portion (U₁) of the data. In one example, a result B may be computed where B=DES(MCKL) [U1], where DES is a Data Encryption Standard algorithm using a first portion (L) of the MAC Card Key (MCKL).

At block 1808 an additional operation may be performed on the result B. Specifically, the result B may be exclusively or′d (XOR) with a second portion of the data (U₂).

The updated result B may be further processed at block 1810. For example, result B may be further processed by applying the DES algorithm using MCKL again to B. The result B of block 1810 may further be processed at block 1812. Specifically, the result B may be processed by the inverse DES with a second portion (R) of the MCK (MCKR). And at block 1814, the MAC M may be determined by applying the DES algorithm with the MCKL to result B of block 1812.

FIG. 19 illustrates an example of a message 1900 that may be communicated by a contactless card to perform the functions described herein. One or more of the fields in message 1900 may also be utilized to route the message 1900 through the switchboard system and perform authentication/validation techniques.

In embodiments, the message 1900 includes an applet version 1902 field, an issuer discretionary indicator 1904 field, an Issuer Identifier 1906 field, a pKey ID 1908 field, a pUID 1910 field, a pATC 1912 field, a nonce 1914 field, and an encrypted cryptogram 1916.

In embodiments, the fields may be in plain text or encrypted. For example, the applet version 1902 field may include an applet version in plain text. The applet version to indicate which applet version is installed on a contactless card and may be used by the other systems to determine how to process the message 1900 when communicated. For example, different Applet versions require different validation logic, e.g., an older message may be routed through the issuer system to perform various operations for validation, while a newer message may be routed through the switchboard system to perform the various operations, including validation.

In embodiments, the message 1900 includes an issuer discretionary indicator 1904 field that may include issuer data and set at the time of personalization. In addition, the message 1900 includes an Issuer Identifier 1906 field that may include a unique ID assigned to the entity issuing the card, e.g., the issuer. For example, each issuer may be assigned a unique identifier during an onboarding operation when joining the system. The issuer ID can be used by the switchboard system 1308 to route a message and its contents to the appropriate services that are associated with that particular issuer.

In embodiments, the message 1900 includes a pKey ID 1908 field. In some instances, the pKey ID 1908 field may include data that identifies a set of master keys for a card issuer. The issuer's set of master keys may utilize each cards set of derived master keys or unique derived keys (UDK). Further, each card's own set of master keys (UDKs) may be generated during the personalization of the card. The card's UDKs may be utilized to generate session keys that are used to generate the application cryptogram. The session keys generated by a card may be regenerated by a system, e.g., the validator system, utilizing pKeyID to identify the issuer's masters keys to regenerate session keys by the system to perform a validation.

In embodiments, each contactless card 1302 is given a unique 16-decimal digit identity (pUID) at the time of personalization. Derivation of the card applet's unique keys using the pUID is performed off-card. The resultant Application Keys are injected during the personalization of the card. In embodiments, a card's Application Keys are the same as the card's derived master keys or UDKs. The process for deriving the Application Keys (UDKs) is described in FIG. 14, flow 1400.

The message 1900 may include a pUID 1910 field, including a card unique identifier assigned to the contactless card at personalization time. The pUID 1910 field data may be a combination of alphanumeric characters used to uniquely identify each card and associated with a user.

In embodiments, the message 1900 includes a pATC 1912 field configured to hold a counter value. The counter value keeps a count of reads (taps) made on the contactless card in a hexadecimal format in one example. Further, a counter value may be used to generate session keys to encrypt at least a portion of a message.

In embodiments, each time a message 1900 is created, a new session key is derived and utilized to generate one or more portions of the message 1900. Specifically, a session key is used to calculate the cryptographic MAC (Application Cryptogram). The card's applet supports a session key derivation option to generate a unique cryptogram session key ASK as discussed in FIG. 15, flow 1500 and unique encipherment session key (DESK) as discussed in flow 1508. The generation of the cryptogram is discussed in flow 600 and flow 1700. Further the cryptogram may decrypted in accordance with flow block 1708.

In embodiments, a portion of the data provided in message 1900 is static and set on the card during the personalization of the card and other data is dynamic and may be generated by the card during an operation, e.g., when a read operation is being performed. Note that in some instances, the static information may be updateable, but may require the customer and card to go through a secure update process, which may be controlled by the issuer.

In embodiments, the contactless card 1302 may communicate a message between a device, such as a mobile device, during a read operation. For example, in response to the contactless card 1302 being tapped onto a surface of the device, e.g., brought within wireless communication range, a read operation may be performed on the contactless card 1302, and the contactless card 1302 may generate and provide the message to the device. For example, once within range, the contactless card 1302 and the device may perform one or more exchanges for the contactless card 1302 to send the message to the device.

The wireless communication may be in accordance with a wireless protocol, such as near-field communication (NFC), Bluetooth, WiFi, and the like. In some instances, a message may be communicated between a contactless card 1302 and a device via wired means, e.g., via the contact pad 608, and in accordance with the EMV protocol.

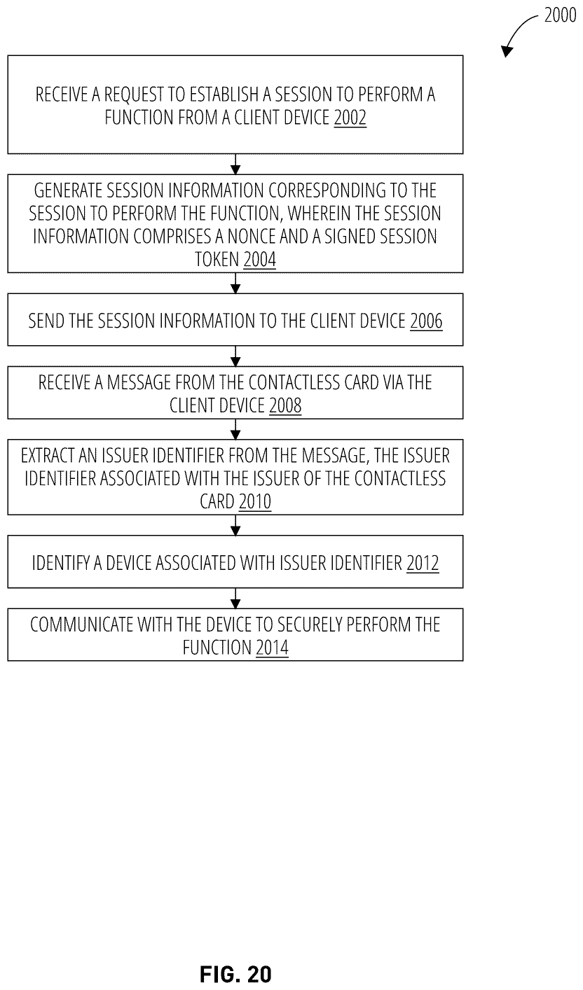

FIG. 20 illustrates an example of routine 2000 in accordance with embodiments discussed herein. In block 2002, the routine 2000 includes receiving, by a node in a system, a request to establish a session to perform a function from a client device, wherein the function is at least partially performed utilizing a contactless card. In some instances, the node may be one of a plurality nodes of a switchboard system. The node may be previously selected by the sending device via a DNS operation performed.

In block 2004, the routine 2000 includes generating, by the node, session information corresponding to the session to perform the function, wherein the session information comprises a nonce and a signed session token. The nonce and/or signed session token may be utilized by systems to perform the functions described herein while ensuring the node routing the data is authenticate, the message from the contactless card is authenticate, and to keep track of the session for the function.

In block 2006, routine 2000 includes sending, by the node, the session information to the client device. The client device may communicate with a contactless card to receive data from the card to authenticate and perform a function. In some instances, the client device may send the nonce from the node to the contactless card. The contactless card may utilize the nonce when generating the message to communicate back to the client device and finally, the node, e.g., incorporates it into a cryptographic portion of the message (see FIG. 19).

In block 2008, routine 2000 includes receiving, by the node, a message from the contactless card via the client device. The message may be generated by the contactless card. FIG. 19 illustrates one example of a message 1900. In some embodiments, the node verifies the message. For example, the node may verify a nonce in the message and a signed session token.

In block 2010, routine 2000 extracts, by the node, an issuer identifier from the message, the issuer identifier associated with the issuer of the contactless card. In some instances, the issuer identifier may be in a plaintext format.

In block 2012, routine 2000 identifies, by the node, a device associated with the issuer identifier. For example, the node may perform a lookup to determine a server associated with the issuer identifier and the function to be performed.

In block 2014, routine 2000 communicates, by the node, with the device to securely perform the function.

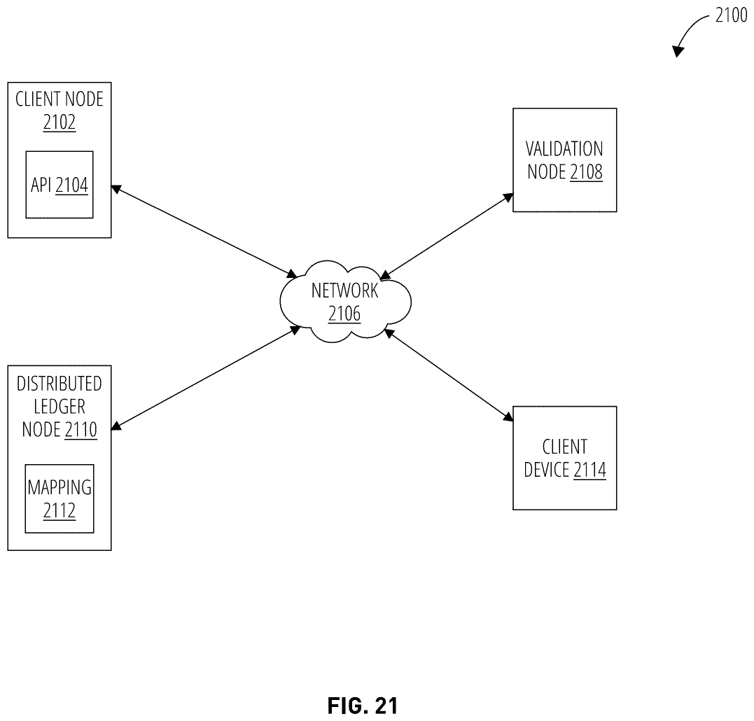

FIG. 21 illustrates a distributed network authentication system 1100 according to an example embodiment. As further discussed below, system 1100 can include client node 2102, API 2104, network 2106, distributed ledger node 2110, mapping 2112, and client device 2114. Although FIG. 21 illustrates single instances of the components, system 1100 can include any number of components.

System 1100 can include a client node 2102, which can be a network-enabled computer as described herein. In some examples, client node 2102 can be a server, which can be a dedicated server computer, a bladed server, or can be a personal computer, a laptop computer, a notebook computer, a palm top computer, a network computer, a mobile device, a wearable device, or any processor-controlled device capable of supporting the system 1100.

In some examples, client node 2102 can execute one or more applications, such as software applications, that enable, for example, network communications with one or more components of system 1100, transmit and/or receive data, and perform the functions and processes described herein.

The client node can contain an API 2104. For example, various different APIs can be provided for an application (e.g., executed on a computing device, such as a network-enabled computer) that can interact with a service. For example, an application executed on a device (e.g., a smart phone, smart watch, tablet, laptop, or other device) call interact with a web-based service by calling the API 2104 to interact with the service, such as by performing a remote call to an API for interacting with a web-based service.

API 2104 can be provided in the form of a library that includes specifications for routines, data structures, object classes, and variables. In some cases, such as for representational state transfer (REST) services, an API (e.g., a REST API or RESTful API, or an API that embodies some RESTful practices) is a specification of remote calls exposed to the API consumers (e.g., applications executed on a client computing device can be consumers of a REST API by performing remote calls to the REST API). REST services generally refer to a software architecture for coordinating components, connectors, and/or other elements, within a distributed system (e.g., a distributed hypermedia system).

Client node 2102 can communicate with one or more other components of system 1100 either directly or via network 2106. Network 2106 can comprise one or more of a wireless network, a wired network or any combination of wireless network and wired network, and may be configured to connect the components of system 1100. While FIG. 21 illustrates communication between the components of system 1100 through network 2106, it is understood that any component of system 1100 can communicate directly with another component of system 1100, e.g., without involving network 2106.

System 1100 can include a validation node 2108, which can be a network-enabled computer as described herein. In some examples, validation node 2108 can be a server, which can be a dedicated server computer, a bladed server, or can be a personal computer, a laptop computer, a notebook computer, a palm top computer, a network computer, a mobile device, a wearable device, or any processor-controlled device capable of supporting the system 1100.

In some examples, validation node 2108 can execute one or more applications, such as software applications, that enable, for example, network communications with one or more components of system 1100, transmit and/or receive data, and perform the functions and processes described herein.

In some examples, each validation node can be associated with a routing number, and the routing number identifies the entity controlling the keys for the authentication namespace. The authentication namespace can be related to one or more of a particular entity, a particular set of cards, or a particular set of security keys (e.g., master keys, diversified keys, session keys) associated with an entity, a set of cards, or a type of cards.

System 1100 can include a distributed ledger node 2110, which can be a network-enabled computer as described herein. In some examples, distributed ledger node 2110 can be a server, which can be a dedicated server computer, a bladed server, or can be a personal computer, a laptop computer, a notebook computer, a palm top computer, a network computer, a mobile device, a wearable device, or any processor-controlled device capable of supporting the system 1100.

In some examples, distributed ledger node 2110 can execute one or more applications, such as software applications, that enable, for example, network communications with one or more components of system 1100, transmit and/or receive data, and perform the functions and processes described herein.

Distributed ledger node 2110 can containing a mapping 2112. In some examples, mapping 2112 can be in the form of one or more databases. Exemplary databases can include, without limitation, relational databases, non-relational databases, hierarchical databases, object-oriented databases, network databases, and any combination thereof. The one or more databases can be centralized or distributed. The one or more databases can be hosted internally by any component of system 1100, or the one or more databases can be hosted externally to any component of the system 1100. In some examples, the one or more databases can be contained in the distributed ledger node 2110, and in other examples the one or more databases can be stored outside of distributed edger node 2110 but in data communication with distributed ledger node 2110. The one or more databases can be implemented in a database programming language. Exemplary database programming languages include, without limitation, Structured Query Language (SQL), MySQL, HyperText Markup Language, JavaScript, Hypertext Preprocessor Language, Practical Extraction and Report Language, Extensible Markup Language, and Common Gateway Interface. Queries made to the one or more databases can be implemented in the same database programming language used to implement the one or more databases. For example, if the one or more databases are an SQL database, then queries made to the database can be made in SQL (e.g., SELECT column1, column2 FROM table1, table2 WHERE column2=′value′;). It is understood that the one or more databases can be implemented in any database programming language and that the programming implementation of the query can be adjusted as necessary for compatibility with the one or more databases and to reflect the particular information to be queried.

In some examples, the one or more databases can be contained within distributed ledger node 2110. In other examples, the one or more databases can be remote from distributed ledger node 2110 but in data communication with distributed ledger node 2110. Data communication between the one or more databases and distributed ledger node 2110 can be a direct data communication or data communication via a network, such as the network 2106.

In some examples, client node 2102 can be in data communication with distributed ledger node 2110. Distributed ledger node 2110 can contain mapping 2112. Mapping 2114 may include, e.g., a mapping between a validation node address and the validation node 2108, a mapping between a routing number and a validation node address, and/or a mapping between a routing number and validation node 2108. In some examples, mapping 2112 can include a digital signature associated with an entity having permission to validate for a routing number. Based on one or more of these associations, client node 2102 can call validation node for validation and/or provide direction to the client device to reach the appropriate validation node. This can be accomplished by calling a validation API associated with validation node 2108.

In some examples, iterations of the mappings described herein, such as mapping 2112, can also include a software or applet version number. The version number can be used to identify a validation node or validation node address or choose between multiple validation addresses for one validation node.

In some examples, client node 2102 and distributed ledger node 2110 can be permissioned (e.g., allowed to join a network) with the aid of a certificate and/or a cryptographic authentication mechanism (e.g., a non-fungible token). The certificate and/or a cryptographic authentication mechanism may be issued by, e.g., a consortium authority or other administrative entity associated with the distributed network. If granted appropriate permissions, distributed ledger node 2110 can update mapping 2112 to reflect a different association between, e.g., a routing number, a validation node address, and a validation node. In some examples, degrees of permissions can be issued. For example, if client node 2102 were to function to route data to validation node 2108 (or other validation nodes), client node 2102 can be given a certain level of permissions. As another example, if distributed ledger node 2110 were to have the capability to update mapping 2112, distributed ledger node 2110 can have a different, higher level of permissions.

System 1100 can include a client device 2114, which can be a network-enabled computer as described herein. In some examples, distributed ledger node 2114 can be a server, which can be a dedicated server computer, a bladed server, or can be a personal computer, a laptop computer, a notebook computer, a palm top computer, a network computer, a mobile device, a wearable device, or any processor-controlled device capable of supporting the system 1100. Client device 2114 also may be a mobile device; for example, a mobile device may include an iPhone, iPod, iPad from Apple® or any other mobile device running Apple's iOS® operating system, any device running Microsoft's Windows® Mobile operating system, any device running Google's Android® operating system, and/or any other smartphone, tablet, or like wearable mobile device. In some examples, client device 2114 can be in data communication with another network-enabled computer not shown in FIG. 21, such as a smart card (e.g., a contactless card or a contact-based card).

In some examples, client device 2114 can execute one or more applications, such as software applications, that enable, for example, network communications with one or more components of system 1100, transmit and/or receive data, and perform the functions and processes described herein.

In some examples, upon receipt of an authentication request, client device 2114 can call (e.g., via an API) client node 2102. The call can include a routing number and/or an applet or software version number, and client node 2102 can query distributed ledger node 2110 and mapping 2112. Once the query returns the identification of a validation node (e.g., validation node 2108) and/or a validation node address associated with that routing number and/or applet or software version, client node 2102 can reply to client device 2114. Client device 2114 can then proceed with authentication with the validation node. The authentication can be performed by, e.g., the systems and methods described herein, such as by the generation, encryption, transmission, decryption, and validation of a cryptogram as described herein.

In some examples, client node 2102 can be co-resident with validation node 2108. In these examples, client node 2102 can handle the authentication in a single call from client device 2114. In some examples, this can be acceptable only if it is permissible for the full authentication transmission (e.g., a cryptogram as described herein) to be sent to client nodes that are not involved in authentication.

In some examples, if client node 2102 receives, from client device 2114, a routing number that is not handled by its location, client node 2102 can return a code indicating that this routing number is not handled, along with validation node address for the responsible validation node. Client device 2114 can then send the full authentication transmission to validation node 2108 using the received validation node address.

In some examples, client node 2102 can enter the distributed network with different permissions. For example, client node 2102 can be a read-only router of data. As another example, client node 2102 can have permission to send messages to distributed ledger node 2110 updating one or more routing paths for one or more routing numbers. However, client node 2102 would be prevented from updating one or more routing paths for one or more routing numbers for other entities that control other routing numbers which are not associated with client node 2102 or that did not grant this permission. As another example, distributed ledger node 2110 can contain contracts and/or records that can validate the permission of a specific entity to change a specific routing record based on its digital signature. As another example, the consortium authority or other administrative entity controlling the distributed network can have additional privileges to, without limitation, add new members (e.g., client nodes, distributed ledger nodes, validation nodes, and/or client devices), add new signature credentials, add new keys, add new certifications, and also to revoke any of the foregoing. In some examples, the foregoing permissions can be delegated to client node 2102, distributed ledger node 2110, and/or validation node 2108, if security, legal, and/or financial conditions are met, however, delegation is not required.

In some examples, one or more APIs can facilitate communication between components of system 1100 via network 2106. In other examples, one or more APIs are not required. Rather, the components of system 1100 could be in direct communication and/or dedicated to one or more specified entities, to allow the specified entities to keep data from being transferred to, transferred from, or transferred via, non-specified entities. This may further promote data security and avoid detection of data traffic patterns by non-specified entities.

In some examples, entities could establish a standard for nodes having APIs based on the intended function of those nodes. For example, a first standard could be established for data routing nodes and a second standard could established for nodes performing mapping and/or authentication functions. As another example, a routing API, a mapping API, and a validation API can be established, which can allow for the same device or hardware configuration to perform these functions. However, the use of keys, including secret keys by validation node 2108 for authentication, can require storage of the keys in one or more HSMs, to promote key security and ensure that the keys are never entered into memory.

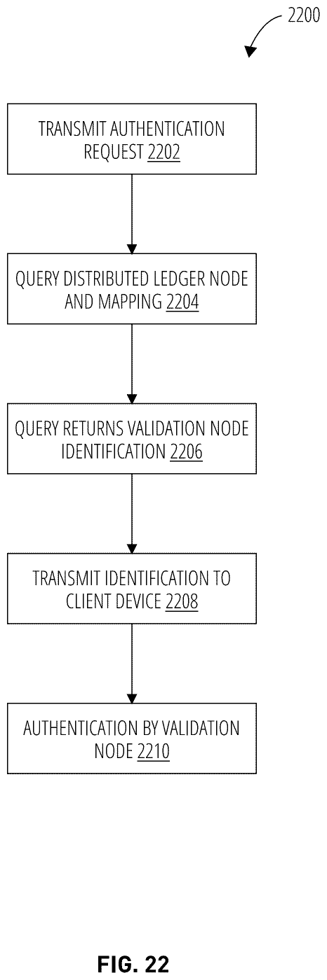

FIG. 22 illustrates a method 2200 performed by a distributed network authentication system according to an example embodiment. For example, the method can be performed by distributed network authentication system 2100 and or by another distributed network authentication system.

In block 2202, a client device can transmit an authentication request to a client node. The authentication request can include, without limitation, a routing number, a software version number, and/or an applet version number. The request can be made by an API call or other communication between the client device and the client node.

In block 2204, after receiving the authentication request, the client node can transmit a query (e.g., via an API call) to a distributed ledger node. The distributed ledger node contain a mapping, and the distributed ledger node can submit the query to the mapping.

In block 2206, the query can return an identification of a validation node and/or a validation node address, and the distributed ledger node can transmit this identification to the client node.

In block 2208, the client node can transmit the identification to the client device. After receiving the identification, the client device can proceed with authentication with the identified validation node and/or validation node address, in block 2210.

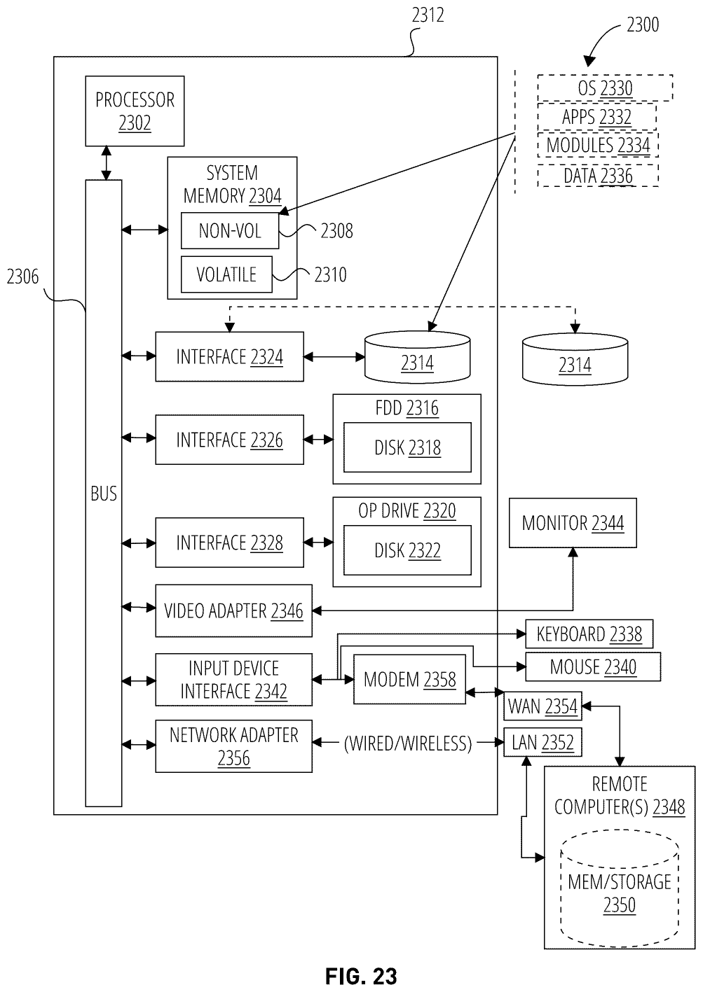

FIG. 23 illustrates an embodiment of an exemplary computer architecture 2300 suitable for implementing various embodiments as previously described. In one embodiment, the computer architecture 2300 may include or be implemented as part of computing architecture 100. For example, the computer architecture 2300 or parts of it can be used to implement the computing device 102, the contactless card 104, the server 106, and the social media platform 304. In some cases, for example, in the case of the contactless card 104, some of the components described herein may not be included.

As used in this application, the terms “system” and “component” are intended to refer to a computer-related entity, either hardware, a combination of hardware and software, software, or software in execution, examples of which are provided by the exemplary computing computer architecture 2300. For example, a component can be, but is not limited to being, a process running on a processor, a processor, a hard disk drive, multiple storage drives (of optical and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers. Further, components may be communicatively coupled to each other by various types of communications media to coordinate operations. The coordination may involve the uni-directional or bi-directional exchange of information. For instance, the components may communicate information in the form of signals communicated over the communications media. The information can be implemented as signals allocated to various signal lines. In such allocations, each message is a signal. Further embodiments, however, may alternatively employ data messages. Such data messages may be sent across various connections. Exemplary connections include parallel interfaces, serial interfaces, and bus interfaces.

The computer architecture 2300 includes various common computing elements, such as one or more processors, multi-core processors, co-processors, memory units, chipsets, controllers, peripherals, interfaces, oscillators, timing devices, video cards, audio cards, multimedia input/output (I/O) components, power supplies, and so forth. The embodiments, however, are not limited to implementation by the computing computer architecture 2300.

As shown in FIG. 23, the computer architecture 2300 includes a computer 2312 comprising a processor 2302, a system memory 2304 and a system bus 2306. The processor 2302 can be any of various commercially available processors. The computer 2312 may be representative of the computing device 102 and/or the server 106.

The system bus 2306 provides an interface for system components including, but not limited to, the system memory 2304 to the processor 2302. The system bus 2306 can be any of several types of bus structure that may further interconnect to a memory bus (with or without a memory controller), a peripheral bus, and a local bus using any of a variety of commercially available bus architectures. Interface adapters may connect to the system bus 2306 via slot architecture. Example slot architectures may include without limitation Accelerated Graphics Port (AGP), Card Bus, (Extended) Industry Standard Architecture ((E)ISA), Micro Channel Architecture (MCA), NuBus, Peripheral Component Interconnect (Extended) (PCI(X)), PCI Express, Personal Computer Memory Card International Association (PCMCIA), and the like.

The computer architecture 2300 may include or implement various articles of manufacture. An article of manufacture may include a computer-readable storage medium to store logic. Examples of a computer-readable storage medium may include any tangible media capable of storing electronic data, including volatile memory or non-volatile memory, removable or non-removable memory, erasable or non-erasable memory, writeable or re-writeable memory, and so forth. Examples of logic may include executable computer program instructions implemented using any suitable type of code, such as source code, compiled code, interpreted code, executable code, static code, dynamic code, object-oriented code, visual code, and the like. Embodiments may also be at least partly implemented as instructions contained in or on a non-transitory computer-readable medium, which may be read and executed by one or more processors to enable performance of the operations described herein.

The system memory 2304 may include various types of computer-readable storage media in the form of one or more higher speed memory units, such as read-only memory (ROM), random-access memory (RAM), dynamic RAM (DRAM), Double-Data-Rate DRAM (DDRAM), synchronous DRAM (SDRAM), static RAM (SRAM), programmable ROM (PROM), erasable programmable ROM (EPROM), electrically erasable programmable ROM (EEPROM), flash memory, polymer memory such as ferroelectric polymer memory, ovonic memory, phase change or ferroelectric memory, silicon-oxide-nitride-oxide-silicon (SONOS) memory, magnetic or optical cards, an array of devices such as Redundant Array of Independent Disks (RAID) drives, solid state memory devices (e.g., USB memory, solid state drives (SSD) and any other type of storage media suitable for storing information. In the illustrated embodiment shown in FIG. 23, the system memory 2304 can include non-volatile 2308 and/or volatile 2310. A basic input/output system (BIOS) can be stored in the non-volatile 2308.

The computer 2312 may include various types of computer-readable storage media in the form of one or more lower speed memory units, including an internal (or external) hard disk drive 2314, a magnetic disk drive 2316 to read from or write to a removable magnetic disk 2318, and an optical disk drive 2320 to read from or write to a removable optical disk 2322 (e.g., a CD-ROM or DVD). The hard disk drive 2314, magnetic disk drive 2316 and optical disk drive 2320 can be connected to the system bus 2306 by an HDD interface 2324, and FDD interface 2326 and an optical disk drive interface 2328, respectively. The HDD interface 2324 for external drive implementations can include at least one or both of Universal Serial Bus (USB) and IEEE 1394 interface technologies.

The drives and associated computer-readable media provide volatile and/or nonvolatile storage of data, data structures, computer-executable instructions, and so forth. For example, a number of program modules can be stored in the drives and non-volatile 2308, and volatile 2310, including an operating system 2330, one or more applications 2332, other program modules 2334, and program data 2336. In one embodiment, the one or more applications 2332, other program modules 2334, and program data 2336 can include, for example, the various applications and/or components of the system 100.

A user can enter commands and information into the computer 2312 through one or more wire/wireless input devices, for example, a keyboard 2338 and a pointing device, such as a mouse 2340. Other input devices may include microphones, infra-red (IR) remote controls, radio-frequency (RF) remote controls, game pads, stylus pens, card readers, dongles, finger print readers, gloves, graphics tablets, joysticks, keyboards, retina readers, touch screens (e.g., capacitive, resistive, etc.), trackballs, track pads, sensors, styluses, and the like. These and other input devices are often connected to the processor 2302 through an input device interface 2342 that is coupled to the system bus 2306 but can be connected by other interfaces such as a parallel port, IEEE 1394 serial port, a game port, a USB port, an IR interface, and so forth.

A monitor 2344 or other type of display device is also connected to the system bus 2306 via an interface, such as a video adapter 2346. The monitor 2344 may be internal or external to the computer 2312. In addition to the monitor 2344, a computer typically includes other peripheral output devices, such as speakers, printers, and so forth.

The computer 2312 may operate in a networked environment using logical connections via wire and/or wireless communications to one or more remote computers, such as a remote computer(s) 2348. The remote computer(s) 2348 can be a workstation, a server computer, a router, a personal computer, portable computer, microprocessor-based entertainment appliance, a peer device or other common network node, and typically includes many or all the elements described relative to the computer 2312, although, for purposes of brevity, only a memory and/or storage device 2350 is illustrated. The logical connections depicted include wire/wireless connectivity to a local area network 2352 and/or larger networks, for example, a wide area network 2354. Such LAN and WAN networking environments are commonplace in offices and companies, and facilitate enterprise-wide computer networks, such as intranets, all of which may connect to a global communications network, for example, the Internet.

When used in a local area network 2352 networking environment, the computer 2312 is connected to the local area network 2352 through a wire and/or wireless communication network interface or network adapter 2356. The network adapter 2356 can facilitate wire and/or wireless communications to the local area network 2352, which may also include a wireless access point disposed thereon for communicating with the wireless functionality of the network adapter 2356.

When used in a wide area network 2354 networking environment, the computer 2312 can include a modem 2358, or is connected to a communications server on the wide area network 2354 or has other means for establishing communications over the wide area network 2354, such as by way of the Internet. The modem 2358, which can be internal or external and a wire and/or wireless device, connects to the system bus 2306 via the input device interface 2342. In a networked environment, program modules depicted relative to the computer 2312, or portions thereof, can be stored in the remote memory and/or storage device 2350. It will be appreciated that the network connections shown are exemplary and other means of establishing a communications link between the computers can be used.

The computer 2312 is operable to communicate with wire and wireless devices or entities using the IEEE 802 family of standards, such as wireless devices operatively disposed in wireless communication (e.g., IEEE 802.11 over-the-air modulation techniques). This includes at least Wi-Fi (or Wireless Fidelity), WiMax, and Bluetooth™ wireless technologies, among others. Thus, the communication can be a predefined structure as with a conventional network or simply an ad hoc communication between at least two devices. Wi-Fi networks use radio technologies called IEEE 802.11 (a, b, g, n, ac, ax, etc.) to provide secure, reliable, fast wireless connectivity. A Wi-Fi network can be used to connect computers to each other, to the Internet, and to wire networks (which use IEEE 802.3-related media and functions).

The various elements of the devices as previously described with reference to FIGS. 1A-12 may include various hardware elements, software elements, or a combination of both. Examples of hardware elements may include devices, logic devices, components, processors, microprocessors, circuits, processors, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), memory units, logic gates, registers, semiconductor device, chips, microchips, chip sets, and so forth. Examples of software elements may include software components, programs, applications, computer programs, application programs, system programs, software development programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. However, determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation.

One or more aspects of at least one embodiment may be implemented by representative instructions stored on a machine-readable medium which represents various logic within the processor, which when read by a machine causes the machine to fabricate logic to perform the techniques described herein. Such representations, known as “IP cores” may be stored on a tangible, machine readable medium and supplied to various customers or manufacturing facilities to load into the fabrication machines that make the logic or processor. Some embodiments may be implemented, for example, using a machine-readable medium or article which may store an instruction or a set of instructions that, if executed by a machine, may cause the machine to perform a method and/or operations in accordance with the embodiments. Such a machine may include, for example, any suitable processing platform, computing platform, computing device, processing device, computing system, processing system, computer, processor, or the like, and may be implemented using any suitable combination of hardware and/or software. The machine-readable medium or article may include, for example, any suitable type of memory unit, memory device, memory article, memory medium, storage device, storage article, storage medium and/or storage unit, for example, memory, removable or non-removable media, erasable or non-erasable media, writeable or re-writeable media, digital or analog media, hard disk, floppy disk, Compact Disk Read Only Memory (CD-ROM), Compact Disk Recordable (CD-R), Compact Disk Rewriteable (CD-RW), optical disk, magnetic media, magneto-optical media, removable memory cards or disks, various types of Digital Versatile Disk (DVD), a tape, a cassette, or the like. The instructions may include any suitable type of code, such as source code, compiled code, interpreted code, executable code, static code, dynamic code, encrypted code, and the like, implemented using any suitable high-level, low-level, object-oriented, visual, compiled and/or interpreted programming language.

The components and features of the devices described above may be implemented using any combination of discrete circuitry, application specific integrated circuits (ASICs), logic gates and/or single chip architectures. Further, the features of the devices may be implemented using microcontrollers, programmable logic arrays and/or microprocessors or any combination of the foregoing where suitably appropriate. It is noted that hardware, firmware and/or software elements may be collectively or individually referred to herein as “logic” or “circuit.”

It will be appreciated that the exemplary devices shown in the block diagrams described above may represent one functionally descriptive example of many potential implementations. Accordingly, division, omission or inclusion of block functions depicted in the accompanying figures does not infer that the hardware components, circuits, software and/or elements for implementing these functions would be necessarily be divided, omitted, or included in embodiments.

At least one computer-readable storage medium may include instructions that, when executed, cause a system to perform any of the computer-implemented methods described herein.

Some embodiments may be described using the expression “one embodiment” or “an embodiment” along with their derivatives. These terms mean that a particular feature, structure, or characteristic described in connection with the embodiment is included in at least one embodiment. The appearances of the phrase “in one embodiment” in various places in the specification are not necessarily all referring to the same embodiment. Moreover, unless otherwise noted the features described above are recognized to be usable together in any combination. Thus, any features discussed separately may be employed in combination with each other unless it is noted that the features are incompatible with each other.

It is emphasized that the Abstract of the Disclosure is provided to allow a reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment. In the appended claims, the terms “including” and “in which” are used as the plain-English equivalents of the respective terms “comprising” and “wherein,” respectively. Moreover, the terms “first,” “second,” “third,” and so forth, are used merely as labels, and are not intended to impose numerical requirements on their objects.

What has been described above includes examples of the disclosed architecture. It is, of course, not possible to describe every conceivable combination of components and/or methodologies, but one of ordinary skill in the art may recognize that many further combinations and permutations are possible. Accordingly, the novel architecture is intended to embrace all such alterations, modifications and variations that fall within the spirit and scope of the appended claims.

The foregoing description of example embodiments has been presented for the purposes of illustration and description. It is not intended to be exhaustive or to limit the present disclosure to the precise forms disclosed. Many modifications and variations are possible in light of this disclosure. It is intended that the scope of the present disclosure be limited not by this detailed description, but rather by the claims appended hereto. Future filed applications claiming priority to this application may claim the disclosed subject matter in a different manner, and may generally include any set of one or more limitations as variously disclosed or otherwise demonstrated herein.

What is claimed is:

1. A method, comprising:
receiving, by a server, a request to authenticate an identify of a publisher to publish a post;
receiving, by the server, encrypted data from a computing device, the encrypted data generated by a contactless card and communicated to the server via the computing device;
decrypting, by the server, the encrypted data based on a key associated with the contactless card;
authenticating, by the server based on the decryption, the identity of the publisher; and
in response to the authenticating being successful, sending an indication the publisher is authentic to enable display of a status symbol on the post indicative that the identity of the publisher is authentic.

2. The method of claim 1, further comprising, in response to the authenticating not being successful, sending an indication the publisher is not authentic.

3. The method of claim 2, wherein the indication indicates the publisher is not authentic, the status symbol is not presented.

4. The method of claim 1, further comprising activating, by the server based on the authentication of the user, one or more attributes associated with the post.

5. The method of claim 4, wherein the one or more attributes comprise amount of memory storage, access to one or more account functions, and access to one or more account databases.

6. The method of claim 1, wherein the server is an authentication server and the displaying of the status symbol comprises instructing, by the authentication server, another server associated with the post to display the status symbol.

7. The method of claim 1, wherein displaying the status symbol comprises displaying one or more of an icon, an image, a text, and a user-interface element.

8. The method of claim 1, wherein displaying the status symbol comprises displaying meta-information associated with the authenticating the identity of the publisher.

9. A computing apparatus comprising:
a processor; and
a memory storing instructions that, when executed by the processor, configure the processor to:
receive a request to publish a post on a social media site;
determine to authenticate an identity of a publisher of the post;
perform an exchange of data with a contactless card, the exchange to include receiving encrypted data generated by the contactless card;
send the encrypted data to a server to authenticate the publisher of the post;
receive an indication the publisher is authentic; and
cause the post to publish on the social media set with an indication that the publisher is authentic based on the indication.

10. The computing apparatus of claim 9, further comprising activating one or more attributes associated with the post.

11. The computing apparatus of claim 10, wherein the one or more attributes comprise amount of memory storage, access to one or more account functions, and access to one or more account databases.

12. The computing apparatus of claim 9, wherein the indication comprises a status symbol.

13. The computing apparatus of claim 12, wherein the status symbol comprises one or more of an icon, an image, a text, a user-interface element, or any combination thereof.

14. The computing apparatus of claim 9, wherein causing the post to publish with the indication comprises displaying meta-information associated with authenticating the identity of the publisher.

15. A system comprising:
a computing device;
a first server of a social media system;
a second server configured to authenticate publishers of posts on the social media system, the second server configured to:
receive, from the first server, a request to authenticate a publisher of a post;
receive, from the computing device, encrypted data generated by a contactless card;
perform an authentication operation on the encrypted data;
in response to the publisher being successfully authenticated, send an authenticated indication to the first server of the social media, the first server to publish the post with a status symbol; and
in response to the publisher not being successfully authenticated, send an unauthenticated indication to the first server of the social media, the first server to publish the post without the status symbol.

16. The system of claim 15, wherein the authentication operation comprises the second server to:
decrypt the encrypted data with a key associated with the contactless card; and
compare the decrypted data with stored data associated with the contactless card.

17. The computing apparatus of claim 16, wherein the authentication operation comprises the second server to:
decrypt the encrypted data with a public key associated with the contactless card; and
verify the encrypted data is signed with the private key associated with the contactless card.

18. The computing apparatus of claim 15, wherein the status symbol comprises one or more of an icon, an image, a text, a user-interface element, or any combination thereof.

19. The computing apparatus of claim 15, wherein the first server to publish the post with meta-information associated with authenticating an identity of the publisher when the publisher is authenticated.

20. The computing apparatus of claim 15, wherein the encrypted data is encrypted by the contactless card with a private key or a diversified key.
